(19) United States
(12) Patent Application Publication
(10) Pub. No.: US 2021/0307325 A1
(43) Pub. Date: Oct. 7, 2021

(54) COMPOUNDS AND METHODS OF REDUCING NEMATODE INFECTION IN PLANTS

(71) Applicants: Bao-Hua Song, Harrisburg, NC (US); Hengyou Zhang, Charlotte, NC (US)

(72) Inventors: Bao-Hua Song, Harrisburg, NC (US); Hengyou Zhang, Charlotte, NC (US)

(21) Appl. No.: 17/240,696

(22) Filed: Apr. 26, 2021

Related U.S. Application Data
(63) Continuation-in-part of application No. 16/861,977, filed on Apr. 29, 2020, now abandoned.
(60) Provisional application No. 62/842,660, filed on May 3, 2019.
(60) Provisional application No. 63/168,691, filed on Mar. 31, 2021.

(51) Int. Cl. A01N 37/10; A01G 7/06

(52) U.S. Cl. CPC A01N 37/10; A01G 7/06

(57) ABSTRACT

The present disclosure describes methods of reducing nematode infection in plants. A method may include contacting a plant or plant part thereof, and/or a growing media in which the plant is grown, with a composition comprising at least one water-soluble phenolic acid in an amount effective to reduce nematode infection. The at least one water-soluble phenolic acid may be 4-hydroxybenzaldehyde and/or 3,4-hydroxybenzoic acid and/or 2,3-dihydroxybenzoic acid, thereby reducing the number of soybean cyst nematodes.

### RELATED APPLICATION(S)

The present application is a continuation-in-part of U.S. patent application Ser. No. 16/861,977 filed Apr. 29, 2020 which in turn claims priority to and the benefit of U.S. Provisional Patent Application Ser. No. 62/842,660, filed May 3, 2019, the disclosures of which is hereby incorporated herein by reference in their entirety. The present application further claims priority to and the benefit of U.S. Provisional Patent Application No. 63/168,691 filed Mar. 31, 2021, the disclosure of which is hereby incorporated herein by reference in its entirety.

### FIELD

The present disclosure is directed generally toward crop pest management, and more particularly, reducing soybean cyst nematode infection.

### BACKGROUND OF THE INVENTION

Soybean (Glycine max L. merr) is an important legume crop grown worldwide providing 69% and 30% of dietary protein and oil, respectively. However, its production is severely challenged by soybean cyst nematode (SCN, Heterodera glycines Ichinohe), the most economically damaging pest of soybean causing estimated approximately $1.5 billion of soybean loss in the United State annually. In total, 16 races of SCN have been identified worldwide. In the United States, SCN has spread to all major soybean-growing states since its initial discover in the North Carolina in 1954. An SCN population existing in an infested field often habitats as a mixture of several of those races, with one or more of them dominate. The variability in SCN composition and uncertainty of race shifts makes it one of the biggest challenges for soybean breeders seeking effective management of SCN.

Although a number of source of SCN resistance have been identified, studies associated with soybean-SCN interaction are restricted to limited resistant cultivated soybeans and certain HG types, such as Peking and PI88788, two major sources of SCN resistance in providing resistance of most commercial cultivars in the USA, as well as race 3 (HG type 0), an important race of SCN prevalent in the Midwestern soybean growing States. Recent studies have shown that the resistance of Peking-type soybeans requires both the rhg1-a and Rhg4 alleles, while the resistance of PI88788-type soybeans requires only rgh1-b allele, implying that underlying mechanism is far more complex. The loci rhg1 and Rhg4 has been identified in many other resistant genotypes in combination with different HG types, with the efforts mostly done by linkage mapping and genome-wide association mapping in the past decades. These results have shown that, as observed in other domestication traits domestication and human selection have resulted in a reduction of genetic variation associated with SCN resistance. Over-use of the limited resistance source in breeding program has resulted in genetic vulnerability in the derived resistant cultivars because of the shift in virulence of SCN. Thus, identifying the novel source of SCN resistance is urgently needed. Previous DNA marker-based study and whole genome-sequencing studies have shown that wild soybean (Glycine soja Sieb. & Zucc), the closest wild relative and progenitor of soybean, retains higher level of genetic diversity compared with cultivated G. max, for example, half of the rare defense-related genes missing in G. max were found in G. soja. Currently, G. soja showing varying resistance to many HG types (races) and novel loci associated with SCN resistance have been identified, whereas, the novel mechanism of SCN resistance that is expected existing in G. soja is unclear.

Plants synthesize numerous natural products critical in plant defense against pathogens and herbivores. Information regarding the involvement of some metabolites, such as plant phenolic compounds, in plants defending against SCN is sparse, and much of the present knowledge of root metabolism comes from the efforts done by transcriptomics-based pathways analysis and targeted metabolite study. Although insightful, the underlying mechanism behind, in particular, the metabolites involved broad-spectrum resistance, remains largely unclear. Linking plant defense with those metabolites requires a comprehensive analysis of metabolome profile, also known as metabolomics. Liquid chromatography-mass spectrometry (LC-MS) is an innovative approach capable of performing non-targeted measurement of hundreds of compounds in complex biological samples. In addition, genetic, genomic, and biochemical resources are available for soybean, including reference genome sequence, gene expression network and atlas, Kyoto Encyclopedia of Genes and Genomes (KEGG) database, a SCN-resistant G. soja and its gene expression profile associated with SCN resistance. These resources make G. soja an ideal model plant used to elucidate defense mechanism in legumes, especially the nematodes parasitic to other legume hosts, using an integrated metabolic and transcriptomic analyses, providing a comprehensive understanding of gene-to-metabolite networks underlying SCN resistance in soybean roots.

### SUMMARY

Embodiments of the present invention are directed to a method of reducing soybean cyst nematode infection in a plant. The method may include contacting the plant or plant part thereof, and/or a growing media in which the plant is grown, with a composition including at least one water-soluble phenolic acid in an amount effective to reduce nematode infection, wherein the at least one water-soluble phenolic acid is 4-hydroxybenzaldehyde and/or 3,4-hydroxybenzoic acid, thereby reducing the number of soybean cyst nematodes.

Other embodiments of the present invention are directed to a seed. The seed may be coated with a composition comprising at least one water-soluble phenolic acid in an amount effective to reduce infection of the seed by soybean cyst nematodes, wherein the at least one water-soluble phenolic acid is 4-hydroxybenzaldehyde and/or 3,4-hydroxybenzoic acid.

Other embodiments of the present invention are directed to a method of treating a growing media in which a plant or plant part is grown to reduce infestation by soybean cyst nematodes. The method may include contacting the growing media with a composition including at least one water-soluble phenolic acid in an amount effective to reduce infestation by soybean cyst nematodes, wherein the at least one water-soluble phenolic acid is 4-hydroxybenzaldehyde and/or 3,4-hydroxybenzoic acid.

Other embodiments of the present invention are directed to a method of treating a seed to reduce infection by soybean cyst nematodes. The method may include soaking and/or coating the seed in a composition including at least one water-soluble phenolic acid in an amount effective to reduce infection of the seed by soybean cyst nematodes, wherein the at least one water-soluble phenolic acid is 4-hydroxybenzaldehyde and/or 3,4-hydroxybenzoic acid.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A shows two graphs providing a phenotypic comparison between two G. soja genotypes, S54 and S67, under the inoculation of races 2 and 5, respectively (G. max cv. Williams 82 was used as the susceptible check).

FIG. 1B illustrates an experimental design for RNA-seq and metabolomics using LC-MS. Root tissues collected at 3, 5, 8 dpi per condition were pooled for RNA-seq, the remaining 3-5 individuals were used for metabolites extraction followed by LC-MS analysis.

FIG. 1C is a Venn diagram showing the number of differentially expressed genes (DEGs) in each genotype by comparing controls and treatments infected by races 2 and 5, respectively.

FIG. 1D illustrates the number of relative DEGs (rDEGs) after data mining for races 2 and 5, respectively.

FIG. 1E Enrichment of gene ontology (GO) terms for up-regulated rDEGs selected from the rDEGs of FIG. 1D.

FIG. 1F is a Venn diagram showing the number of common-response genes to both races and race-specific response genes (** represents significance at P<0.01).

FIG. 2 illustrates the visualization of the interaction network between the common DEGs (cDEGs) using Cytoscape.

FIG. 3 is a series of graphs showing a qPCR analysis of time-course expression patterns of two Ca2+- and three SA-related signaling genes in race 2 and race 5-treated roots, respectively, in comparison with those of corresponding non-treated control roots at 0, 3, 5, and 8 dpi. “S54_T_R2” is short for race2-treated S54 roots, “S54_C_R2” for non-treated S54 roots, “S67_T_R2” for race2-treated S67 roots, “S67_C_R2” for non-treated S67 control roots, “S54_T_R5” for race5-treated S54 roots, “S54_C_R5” for non-treated S54 control roots, “S67_T_R2” for race5-treated S67 roots, and “S67_C_R5” for non-treated S67 control roots (** represents significance at P<0.01).

FIG. 4A shows plot graphs illustrating principal component 1 and 2 for all high-quality components expressed in all conditions for races 2 and 5, respectively (all samples collected per condition show good clustering with three time points and clearly separate with other conditions).

FIG. 4B is a graph illustrating the number of expressed metabolites in race 2 and race 5 infected roots (constitutively expressed metabolites means, for one race, metabolites have similar high level of expression in treated and non-treated control roots of one genotype but show significantly higher level than the other genotype).

FIG. 4C is a Venn diagram showing commonly-induced and race-specific-induced metabolites (upward arrows represent significant induction).

FIG. 5 displays a proposed scheme for the metabolism of essential metabolites and commonly-induced metabolites by races 2 and 5 and the corresponding chemical structures in phenolic biosynthesis pathways in G. soja roots.

FIGS. 6A-6B are graphs showing the nematocidal activity of 4-hydroxybenzaldehyde and 3,4-dihydroxybenzoic acid and/or 2,3-dihydroxybenzoic acid against races 2 (FIG. 6A) and 5 (FIG. 6B), respectively, after 24 hour incubation (** represents significance at P<0.01).

FIG. 7A illustrates expression patterns of the cDEGs as candidate genes involved in phenolic pathways. PAL, F3H, F3′H, OMT, UDP-GT, GH, and GALT are short for phenylalanine ammonia lyase, galactosyltransferase are indicated with capitalized H, M, G, and GALT, respectively. F3H is short for flavonoid 3-hydroxylase, flavonoid 3′-hydroxylase, UDP-glycosyltransferase, glycosyl hydrolase, and galactosyltransferase, respectively (intensity in the scale indicates the log₂ fold change (treatments/controls) identified in RNA-seq).

FIG. 7B is graphs showing the expression analysis of two PAL genes that showed up-regulation in S54 (dashed rectangle) as observed in FIG. 7A (expression of Glyma.03g181600 and Glyma.03g181700 are illustrated in upper and lower sections, respectively).

FIG. 7C is graphs showing the expression analysis of four selected candidate genes from FIG. 7A at 8 dpi (“*” and “**” represent significance at P<0.05 and P<0.01, respectively).

FIG. 8 illustrates a proposed model of broad-spectrum resistance mechanism in G. soja.

FIGS. 9A-9B show multi-dimensional scales illustrating the RNA-seq result (all samples show good clustering in three biological replicates).

FIGS. 10A-10D show multi-dimensional scales illustrating the RNA-seq result (all samples show good clustering in three biological replicates).

FIGS. 11A-11B show multi-dimensional scales illustrating the RNA-seq result (all samples show good clustering in three biological replicates).

FIG. 12 shows in vitro test of nematicidal activities of 2,3-dihydroxybenzoic acid against J2 nematodes races 2 (a) and 5 (b). X-axis indicates the concentrations of the compounds (mg/mL) applied in treatment. Y-axis shows the percentage of dead J2 nematode (%). ** represents significance at P<0.01.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, fig and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Pursuant to embodiments of the present invention, methods are provided that may reduce soybean cyst nematode infection in a plant. In some embodiments, the method may comprise contacting the plant or plant part thereof with a composition. As used herein, the term “plant part” includes, but is not limited to, reproductive tissues (e.g., petals, sepals, stamens, pistils, receptacles, anthers, pollen, flowers, fruits, flower bud, ovules, seeds, and embryos), vegetative tissues (e.g., petioles, stems, roots, root hairs, root tips, pith, coleoptiles, stalks, shoots, branches, bark, apical, meristem, axillary bud, cotyledon, hypocotyls, and leaves); vascular tissues (e.g., phloem and xylem); specialized cells such as epidermal cells, parenchyma cells, chollenchyma cells, schlerenchyma cells, stomates, guard cells, cuticle, and mesophyll cells; callus tissue; and cuttings.

In some embodiments, the method may comprise contacting a growing media in which the plant and/or plant part is grown with a composition of the invention. As used herein, the term “growing media” refers to any media in which a plant or part thereof may be grown, and includes, but is not limited to, soil, sand, and soilless media. Soilless media can include, but is not limited to, peat and peat-like media (e.g., mosses, humus, etc.), wood residues (e.g., sawdust, leaf mold, etc.), bagasse, rice hulls, perlite, and vermiculite.

In some embodiments, a composition of the invention comprises at least one water-soluble phenolic acid in an amount effective to reduce nematode infection. For example, in some embodiments, the at least one water-soluble phenolic acid may be present in an amount of about 0.125 mg/ml to about 1 mg/ml. In some embodiments, the at least one water-soluble phenolic acid may be 4-hydroxybenzaldehyde and/or 3,4-hydroxybenzoic acid.

In some embodiments, contacting the plant or plant part thereof, and/or growing media in which the plant or plant part thereof is grown with a composition comprising at least one of 4-hydroxybenzaldehyde and 3,4-hydroxybenzoic acid may reduce the number of soybean cyst nematodes infecting the plant. For example, in some embodiments, nematode infection may be reduced in the plant contacted with the composition as described herein when compared to a plant that has not been contacted with the composition (e.g., the number of nematodes in a plant contacted with the composition comprising at least one of 4-hydroxybenzaldehyde and 3,4-hydroxybenzoic acid as described herein is reduced compared to a plant not contacted with the composition).

In some embodiments, contacting the plant or plant part with the composition may occur prior to or concurrently with planting the plant or plant part. In some embodiments, contacting the growing media with the composition may occur prior to, concurrently with, or after planting the plant or plant part in the growing media. In some embodiments, the plant or plant part and/or growing media may be contacted with the composition at least one time (e.g., 1, 2, 3, 4, 5 or more times). In some embodiments, a plant part may be a seed or a root. In some embodiments, the growing media may be a soil, a soilless media or sand.

In some embodiments, the plant is Aeschynomene indica (Indian jointvetch), Beta vulgaris (beetroot), Cajanus cajan (pigeon pea), Fabaceae (leguminous plants), Geranium (cranesbill), Glycine, Glycine max (soybean), Kummerowia striata (Japanese lespedeza), Lamium amplexicaule (henbit deadnettle), Lamium purpureum (purple deadnettel), Lespedeza juncea var. Sericea (Sericea lespedeza), Lupinus (lupins), Lupinus albus (white lupine), Nicotiana tabacum (tobacco), Penstemon Phaseolus vulgaris (common bean), Pisum sativum (pea), Sesbania exaltata (coffeebean (USA)), Solanum lycopersicum (tomato), Stellaria media (common chickweed), Verbascum thapsus (common mullein), Vicia villosa (hairy vetch), Vigna aconitifolia (moth bean), Vigna angularis (adzuki bean), Vigna mungo (black gram), or Vigna radiata (mung bean). In some embodiments, the plant may be a soybean plant.

In some embodiments, methods of the present invention are effective in increasing resistance in the plant or plant part thereof to infection by one or more HG types of soybean cyst nematodes. For example, in some embodiments, the composition may be effective in increasing resistance in the plant or plant part thereof against HG type 1.2.5.7 (race 2) and HG type 2.5.7 (race 5) soybean cyst nematodes (e.g., increased by at least 5% to about 100% as compared to a plant or part thereof not treated using the methods of this invention, e.g., about 5, 10, 15, 20, 25, 30, 35, 40, 45, 50, 55, 60, 65, 70, 75, 80, 85, 90, 95, 100%).

In some embodiments, methods of the present invention provide growing media having reduced infestation by one or more HG types of soybean cyst nematodes (e.g., reduced by at least 5% to about 100% as compared to growing media not treated using the methods of this invention, e.g., about 5, 10, 15, 20, 25, 30, 35, 40, 45, 50, 55, 60, 65, 70, 75, 80, 85, 90, 95, 100%). For example, in some embodiments, the composition may be effective in reducing infestation of growing media by HG type 1.2.5.7 (race 2) and HG type 2.5.7 (race 5) soybean cyst nematodes.

Pursuant to some embodiments of the present invention, a seed is provided with a composition comprising at least one water-soluble phenolic acid in an amount effective that may reduce infection of the seed by soybean cyst nematodes. For example, in some embodiments, the at least one water-soluble phenolic acid may be present in an amount of about 0.125 mg/ml to about 1 mg/ml (e.g., about 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95, 0.975, or about 1 mg/ml). In some embodiments, the at least one water-soluble phenolic acid may be 4-hydroxybenzaldehyde and/or 3,4-hydroxybenzoic acid.

In some embodiments, the seed may be coated with a composition comprising at least one water-soluble phenolic acid. In some embodiments, the seed may be soaked with a composition comprising at least one water-soluble phenolic acid. In some embodiments, the seed may be soaked with a composition comprising at least one water-soluble phenolic acid and coated with a composition comprising at least one water-soluble phenolic acid.

In some embodiments, at least one water-soluble phenolic acid may be mixed with a seed coating polymer, such as, Prism SCP2020 (Precision Laboratories, Waukegan, Ill.). In some embodiments, the phenolic acid may be mixed with the seed coating polymer in a concentration of about 0.1, 1, 10, 50, or about 100 mg/ml. The seeds to be coated (e.g., soybean seeds) may be mixed with the phenolic acid/polymer solution. The freshly coated seeds may then be dried on filter paper in a petri dish and kept over silica gel in desiccators for at least 24 hours. In some embodiments, the seeds may be soaked in at least one water-soluble phenolic acid (e.g., at concentrations of about 0.1, 1, 10, 50, or about 100 mg/ml) for at least 24 hours. The soaked seeds may then be rolled on filter paper to remove any excess surface water.

In some embodiments, a plant developing from the seed of the present invention coated with the composition may have an increased resistance or tolerance to or reduced infection by nematodes as compared to an untreated seed.

In some embodiments, the seed is Aeschynomene indica (Indian jointvetch), Beta vulgaris (beetroot), Cajanus cajan (pigeon pea), Fabaceae (leguminous plants), Geranium (cranesbill), Glycine, Glycine max (soybean), Kummerowia striata (Japanese lespedeza), Lamium amplexicaule (henbit deadnettle), Lamium purpureum (purple deadnettel), Lespedeza juncea var. Sericea (Sericea lespedeza), Lupinus (lupins), Lupinus albus (white lupine), Nicotiana tabacum (tobacco), Penstemon Phaseolus vulgaris (common bean), Pisum sativum (pea), Sesbania exaltata (coffeebean (USA)), Solanum lycopersicum (tomato), Stellaria media (common chickweed), Verbascum thapsus (common mullein), Vicia villosa (hairy vetch), Vigna aconitifolia (moth bean), Vigna angularis (adzuki bean), Vigna mungo (black gram), or Vigna radiata (mung bean). For example, in some embodiments, the seed may be a soybean seed.

Pursuant to embodiments of the present invention, methods of treating a growing media in which a plant or part thereof is grown are provided that may reduce infestation of the growing media by soybean cyst nematodes. In some embodiments, a method of the present invention may comprise contacting the growing media with a composition comprising at least one water-soluble phenolic acid in an amount effective to reduce infestation by soybean cyst nematodes. For example, in some embodiments, the at least one water-soluble phenolic acid may be present in an amount of about 0.125 mg/ml to about 1 mg/ml. In some embodiments, the at least one water-soluble phenolic acid may be 4-hydroxybenzaldehyde and/or 3,4-hydroxybenzoic acid.

In some embodiments, contacting the growing media with the composition may occur prior to, concurrently with, or after planting the plant or a plant part in the growing media. In some embodiments, the method of the present invention may further comprise planting the plant or plant part thereof in the growing media treated with the composition. In some embodiments, the plant part may be a seed. In some embodiments, the growing media may be a soil, a soilless media or sand.

In some embodiments, the method of the present invention may increase the J2 mortality rate of the soybean cyst nematodes in the growing media, for example, when compared to a growing media that has not been contacted with the composition. In some embodiments, the method of the present invention may increase the J2 mortality rate of the soybean cyst nematodes in the plant or plant part thereof, for example, when compared to a plant that has not been contacted with the composition.

Pursuant to embodiments of the present invention, methods of treating a seed to reduce infection by soybean cyst nematodes are provided. In some embodiments, a method of the present invention may comprise soaking and/or coating the seed in a composition comprising at least one water-soluble phenolic acid in an amount effective to reduce infection of the seed by soybean cyst nematodes. In some embodiments, the at least one water-soluble phenolic acid may be 4-hydroxybenzal dehyde and/or 3,4-hydroxybenzoic acid.

The present subject matter will now be described more fully hereinafter with reference to the accompanying EXAMPLES, in which representative embodiments of the presently disclosed subject matter are shown. The presently disclosed subject matter can, however, be embodied in different forms and should not be construed as limited to the embodiments set forth herein. Rather, these embodiments are provided so that this disclosure will be thorough and complete, and will fully convey the scope of the presently disclosed subject matter to those skilled in the art.

### EXAMPLES

The following EXAMPLES provide illustrative embodiments. Certain aspects of the following EXAMPLES are disclosed in terms of techniques and procedures found or contemplated by the present inventors to work well in the practice of the embodiments. In light of the present disclosure and the general level of skill in the art, those of skill will appreciate the following EXAMPLES are intended to be exemplary only and that numerous changes, modifications, and alterations can be employed without departing from the scope of the presently claimed subject matter.

### Example: Finding Solutions in the Wild—Elevated Phenolic Acids Contribute to Broad-Spectrum Resistance to Soybean Cyst Nematode in Wild Soybean

The molecular processes were explored at the levels of transcriptome and metabolome under the infection of two races (race 5 (HG type 2.5.7) and race 2 (HG type 1.2.5.7)) in two G. soja genotypes by applying sequencing-based transcriptomics and LC-MS-based non-targeted metabolomics analysis. This integrative approach allowed the identification and understanding of the mechanisms of broad-spectrum resistance to two races from both molecular and biochemical perspectives, which may provide improvement of soybean yield in the context of the pathogenic variability of SCN.

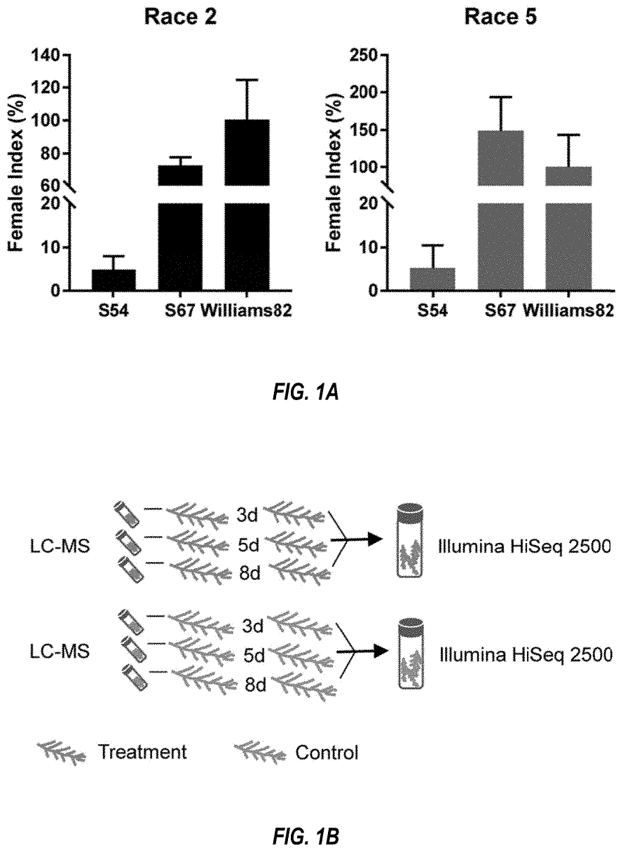

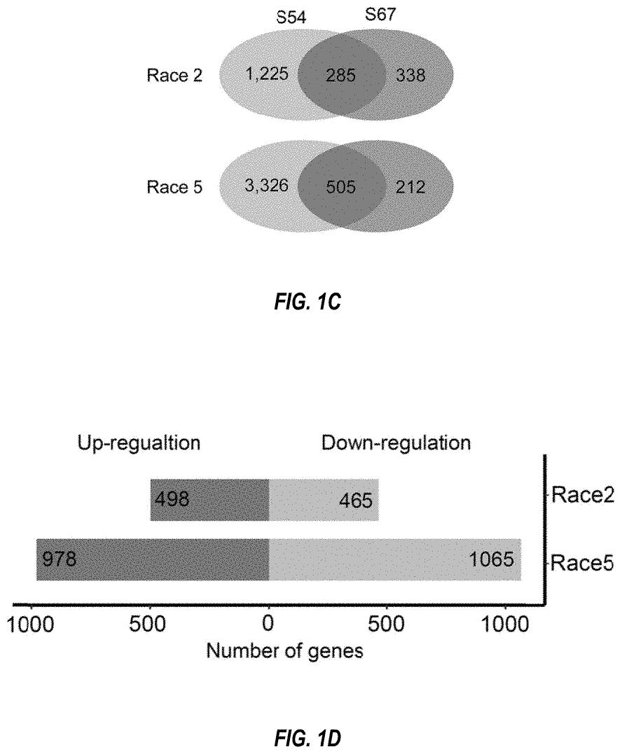

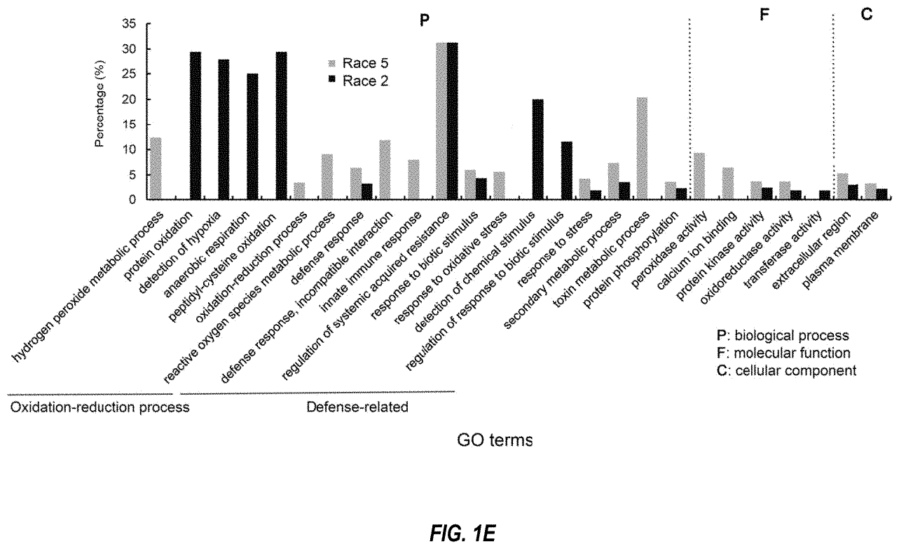

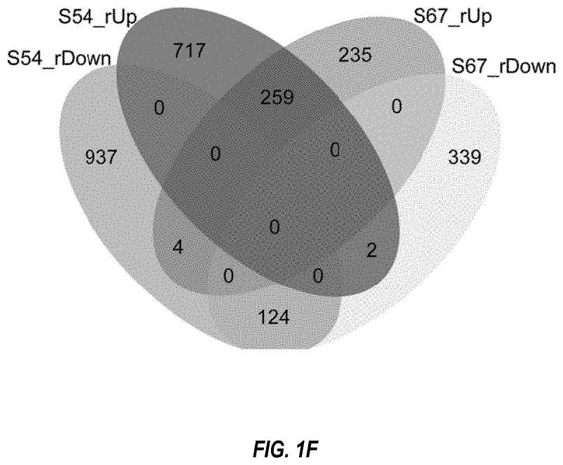

G. soja genotype S54 exhibits resistance to two races. The resistance response of two wild genotypes (S54 and S67) to two races of SCN were obtained by inoculating two-day old seedlings with 2,500 fresh eggs at the environmental-controlled greenhouse with the same condition as SCN stock culturing as described above. Thirty-five days after inoculation, the female adult cysts were counted under a stereoscope. Our screening result indicates that S54 show resistance to both races (FI<10%) while S67 was susceptible to both races (FI>60%) (FIG. 1A). To further test if rhg1a, rhg1b, and Rhg4 can explain SCN resistance in wild soybean S54, the molecular markers developed by Shi et al. were used to genotype S54. The results showed that S54 harbored genotypes that differed from Peking and PI88788 but were the same as susceptible genotype Lee (Table 4).

Global analysis of transcriptome changes in S54 upon H. glycines infection. To understand the molecular mechanism of SCN resistance in G. soja, RNA-seq was used to comparatively examine the transcriptome changes between S54 and S67 infected by race 2 and race 5, respectively (FIG. 1B). Examining transcriptome change in root tissues pooled from 3 dpi, 5 dpi, and 8 dpi allowed us to maximally capture the transcriptome variation associated with resistance response. In total, 24 libraries, twelve per race, were constructed for transcriptome sequencing (see, e.g., Table 3). On average, RNA sequencing generated approximately 20 million of total reads per genotype for each condition. Over 80% of quality-controlled reads, on average, were uniquely mapped on the G. max reference genome (Wm82.a2.v1), representing 64.60-87.93% of reads per library.

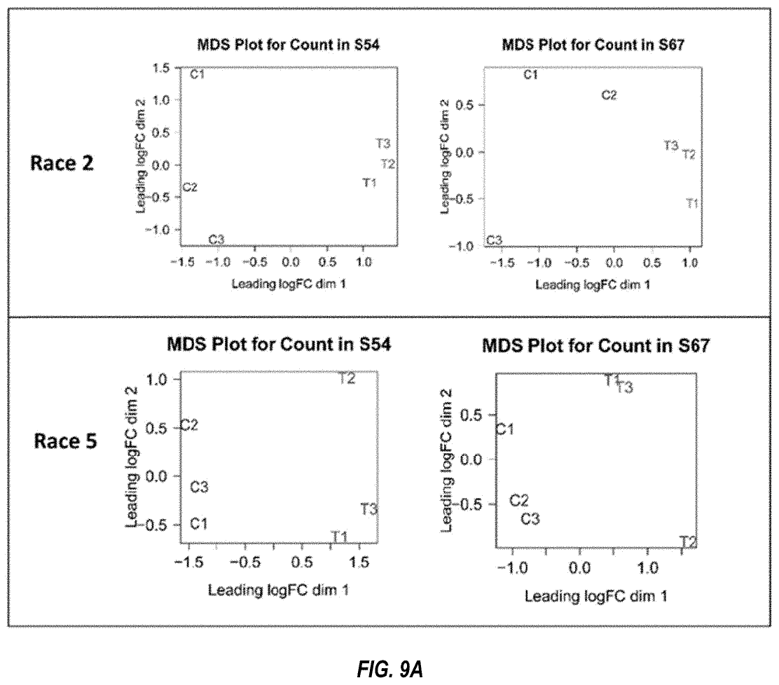

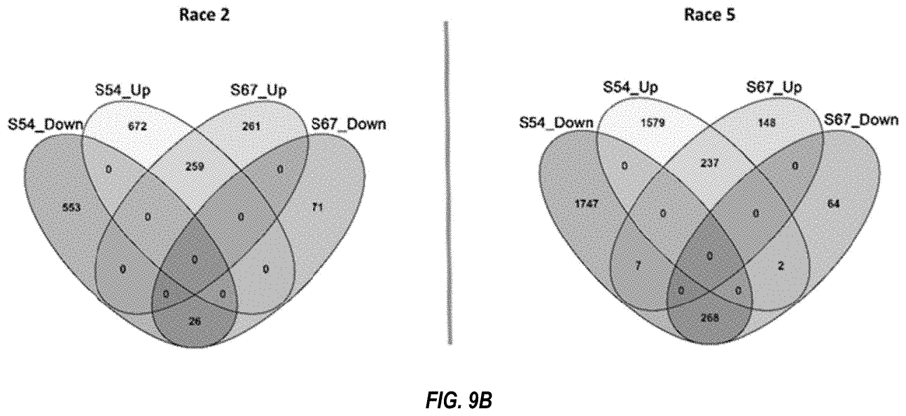

We subsequently identified differentially expressed genes (DEGs) by comparing the transcriptome change between one genotype infected with a single race of H. glycines and the corresponding non-infected controls. Multidimensional scaling plots of transcriptomic data showed that replicates from the same group cluster together while samples from different conditions are well separated (FIG. 9A). After analysis, we found that S54 exhibited more dramatic transcriptomic changes compared with those in S67 after infection by either race 2 or race 5. Briefly, we identified 1,510 and 612 DEGs in S54 and S67, respectively, after race 2 infection, while 3,840 and 726 DEGs in S54 and S67, respectively, after race 5 infection (FIG. 1C). We also found that a small number of DEGs identified in S54 were shared with S67 treated by either race. For example, only 18.9% (285 of 1,510) and 13.4% (514 of 3,840) of DEGs in S54 were commonly differentiately expressed in S67, while these DEGs represented 46.2% (285 of 617) and 70.8% (514 of 726) of DEGs in S67 with races 2 and 5, respectively (FIG. 9B). The difference in the number of genotype-specific DEGs may be associated with different mechanisms of SCN responses in S54 and S67. These results indicate that S54 contains more H. glycines-responsive DEGs than S67, which may account for the differing resistance to either race between S54 and S67.

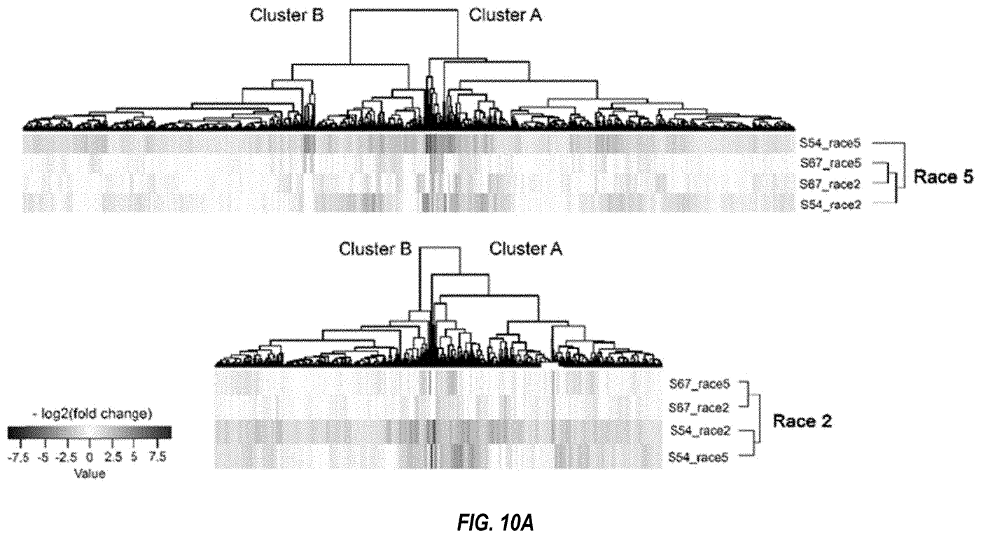

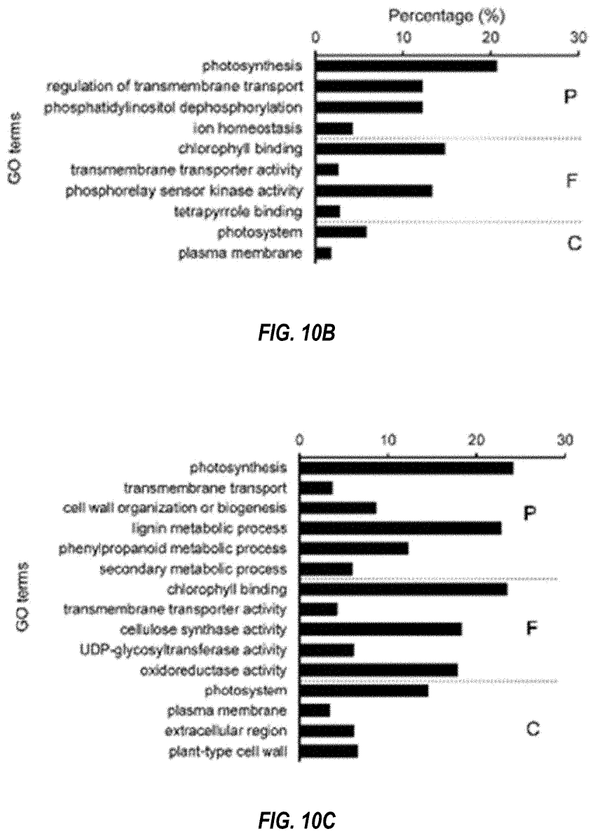

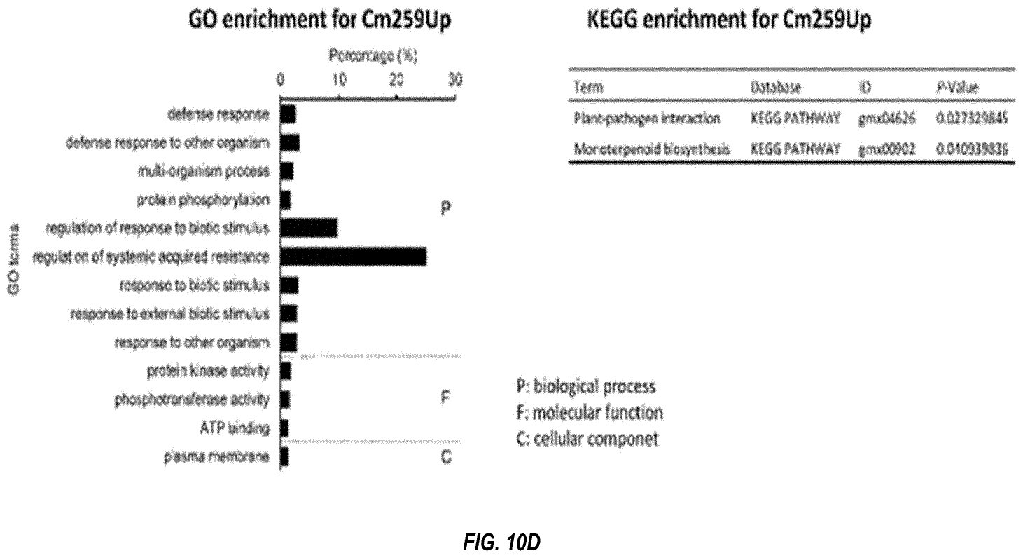

To gain a better understanding of these DEGs and to interpret the molecular mechanism of H. glycines resistance, we introduced a concept of relative DEGs (rDEGs). A DEG with a fold-change value in S54 was greater than 1.5-fold higher than that in S67 under infection by one race was designated rDEG. Based on this criterion, 962 and 2,043 DEGs were identified as rDEGs induced by race 2 and race 5, respectively (FIG. 1D). The expression patterns of these rDEGs were visualized by heat maps (FIG. 10A). We found that the rDEGs for each race were grouped into two large clusters, with “Cluster A” encompassing genes having up-regulated expression in S54 for both races while “Cluster B” containing genes with suppressed expression in S54. The majority of the rDEGs affected by race 5 or race 2 showed similar expression patterns, suggesting that S54 contain a group of genes potentially exhibiting a broad resistance to two testing races. Gene ontology (GO) analysis (FIG. 1E) for these rDEGs in Cluster A showed that many defense-related GO terms were race specifically enriched, while several GO terms were commonly enriched for both rDEGs induced by both races, such as regulation of systemic acquired resistance, response to biotic stimulus, response to stress, protein kinase activity, and plasma membrane. In contrast, GO terms enriched for suppressed rDEGs in Cluster B were primarily associated with photosynthesis, transmembrane transport, chlorophyll binding, and cell wall-related metabolic process and activities (FIGS. 10B and 10C).

Calcium and salicylic acid (SA) signaling genes were significantly inducted. To identify genes potentially involved in broad resistance to both races, we identified the genes present in both rDEG datasets and designated them as common DEGs (cDEGs). The overlapping dataset comprises of 383 cDEGs consisting of 259 up-regulated and 124 down-regulated rDEGs (FIG. 1F), designated as Cm259Up and Cm124Dn, respectively. The GO and KEGG terms enriched in Cm259Up and Cm124Dn were consistent with those enriched in the rDEGs (FIG. 10D), and “regulation of systemic acquired resistance” represented one of the most significantly enriched GO terms for Cm259Up (q<0.05, FIG. 10D). Consistently, KEGG term “Plant-pathogen interaction” (p<0.05) was also among the most enriched terms. In contrast, the enriched GO terms in Cm124Dn were related to photosynthesis and metabolism. Thus, genes within Cm259Up dataset seemed the most relevant.

To understand the mechanism of broad resistance to H. glycines, we manually sorted out these 383 cDEGs based on their functional annotations and previously published literature. In the list, we found that a majority of the cDEGs belonged to gene families that were known to be associated with plant disease defense, as observed in GO and KEGG enrichment analysis (FIG. 10D). The protein kinase (PK) family contained the most infection-induced members (40), comprising of 22 receptor-like kinases (RLKs), 15 non-membrane harboring proteins, and 3 wall-associated kinases, each with a calcium-binding EGF domain. Notably, RLKs and PKs with known functions in disease defense, such as BRI1-associated kinase-1 (BAK1), BAK1-interacting receptor-like kinase (BIR1), and SUPPRESSOR OF BIR1 (SOBIR1), were also strongly induced. In addition to RLKs that proteins associated with pattern-triggered immunity (PTI), nucleotide-binding site leucine-rich repeat (NBS-LRR) involved in effector-triggered immunity (ETI) were also identified. The strong induction of these PTI- and ETI-associated proteins suggests that timely recognition of H. glycines secretions appears to be one of the more important mechanisms during early defense responses. Moreover, expression of transcription factors (WRKYs, MYBs, and NACs), laccase, chitinase, ankyrin repeat family proteins were also strongly induced.

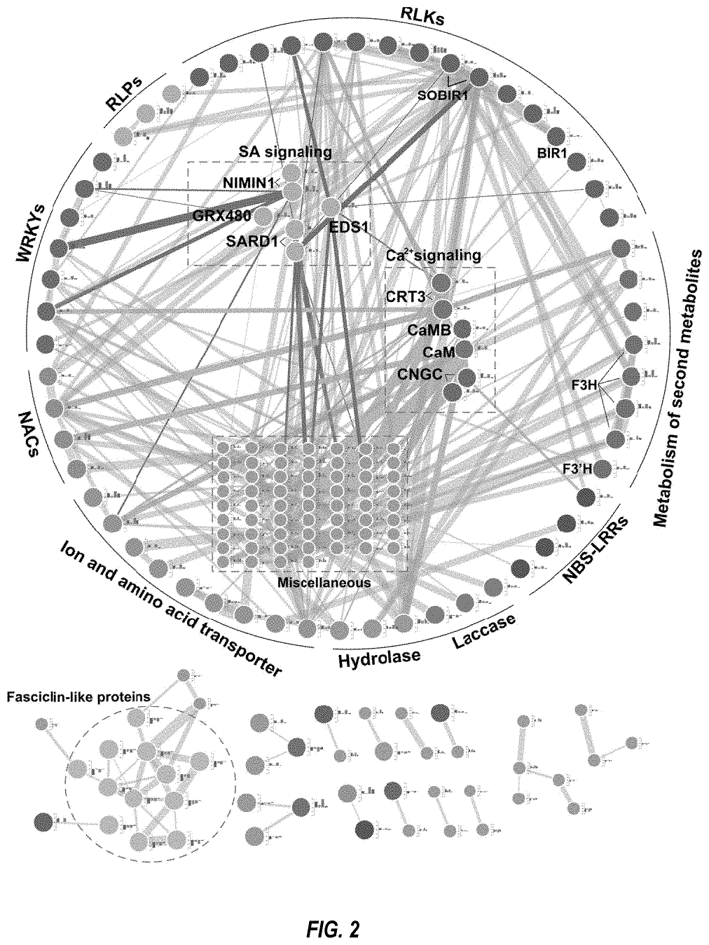

Notably, some important defense regulators involved in calcium- and SA-related signaling were clearly up-regulated (FIG. 2). The induced Ca²⁺/CaM-signaling regulators include Ca²⁺ binding proteins (CaM), CaM-binding proteins (CaMB), cyclic nucleotide gated channels (CNGC), and calreticulin 3 (CRT3), while induced key components involved in SA-related signaling include ENHANCED DISEASE SUSCEPTIBILITY 1 (EDS1), SAMT1, GRX480, SARD1, and NIMIN1. Given the close functional link between Ca²⁺/CaM-signaling and SA-related signaling in plant disease defense, we hypothesize that Ca²⁺/CaM-signaling pathway combined with SA signaling act as important regulators in the activation of the defense responses by connecting the other defense-related cDEGs during the interaction between G. soja and SCN. Thus, we constructed a co-expression network using these cDEGs to understand their functional relationships in the defense response.

As shown in FIG. 2, the majority of the defense-related family genes from the cDEG list were included in the network and appeared to be closely interrelated. In FIG. 2, each node represents a cDEG. Nodes were color coded according to the putative family. Miscellaneous genes not belong to the selected gene families were represented with small nodes colored in gray. The edge links (ribbons) between nodes (genes) represent the regulatory interaction, the edge weight (log likelihood scores) of the interaction. Blue and orange edge links represent the interactions between the defense-related family genes with SA signaling and Ca2+ signaling genes, respectively. The histogram besides each node represents the gene expression pattern of the gene calculated by RNA-Seq (S54_T_R2, S54_C_R2, S54_T_R5, S54_C_R5). RLKs, receptor-like kinase. RLPs, receptor-like proteins. NIMIN1, NIMIN-INTERACTING 1; GRX480, a SA-inducible glutaredoxin family protein; SARD1, SAR DEFICIENT1; CRT3, Calreticulin-3; CaM, Calmodulin; CaMB, Calmodulin-binding protein; CNGC, cylic nucleotide-gated channel.

We found that Ca²⁺/CaM-s(CaM, CaMB, CNGC, and CRT3)- and SA (EDS1, NIMIN1, and GRX480, SARD1) signaling genes have extended connection with other cDEGs that function in gene transcription (such as NIMIN1-WRKY40 links), phosphorylation (SARD1-SOBIR1), recognition of virulent effectors (such as CRT3-RLKs, CNGC-NBS-LRR), hydrolysis, and ion transporter. The tight functional links between these induced Ca²⁺- and SA-signaling pathways with a number of cDEGs with diverse functions in plant defense suggest that both signaling pathways may have important function in the regulation of downstream defense responses, leading to increased resistance to H. glycines in S54.

To further support our hypothesis, we conducted a detailed investigation of two Ca²⁺- and three SA-signaling related genes from cDEGs by examining their expression pattern during the interactions at 3 dpi, 5 dpi, 8 dpi using qPCR. The two Ca²⁺-signaling genes include a CNGC-like gene (Glyma.03G257100) which encodes cyclic nucleotide-gated calcium channels involved in Ca²⁺ influx, and CaM (Glyma.06G258000), which encodes calmodulin (calcium-modulated protein), a calcium-binding messenger; the three SA-related signaling genes were EDS1 (Glyma.06G187300), which encodes an established regulator of salicylic acid levels, PATHOGENESIS-RELATED PROTEIN 1 (PR1) (Glyma.15G062400), a well-established marker genes for SA-signaling; and NIMIN1 (Glyma.10G010100), which encodes proteins involved in interactions with NPR1.

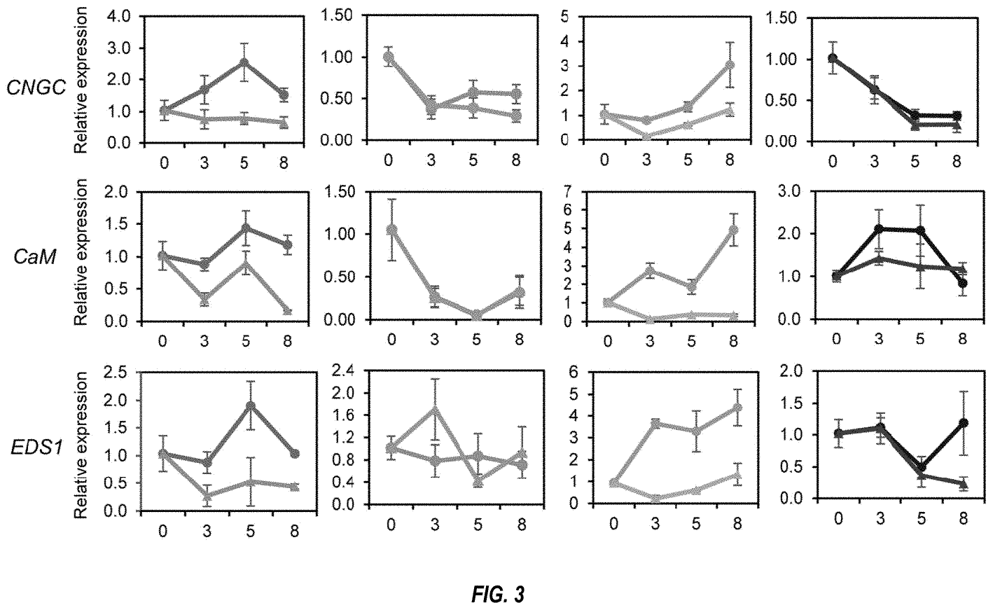

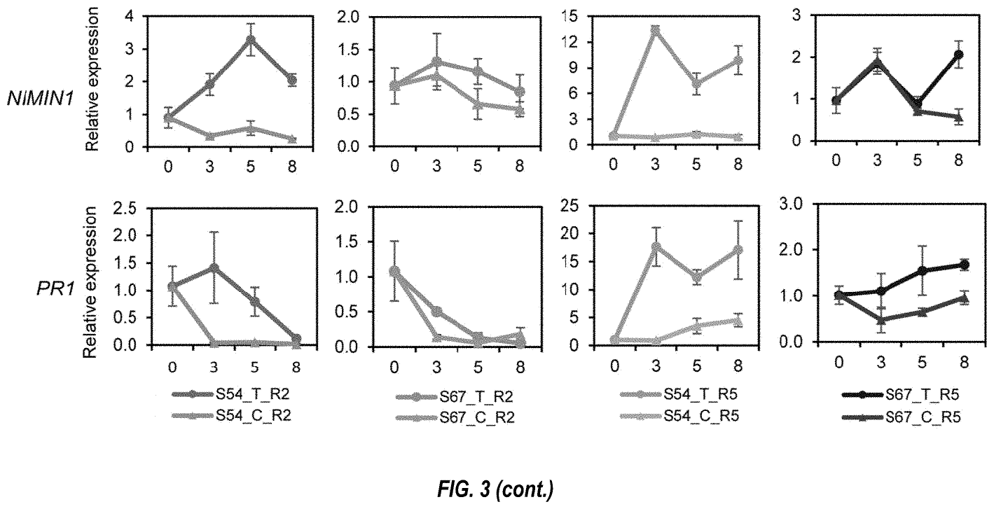

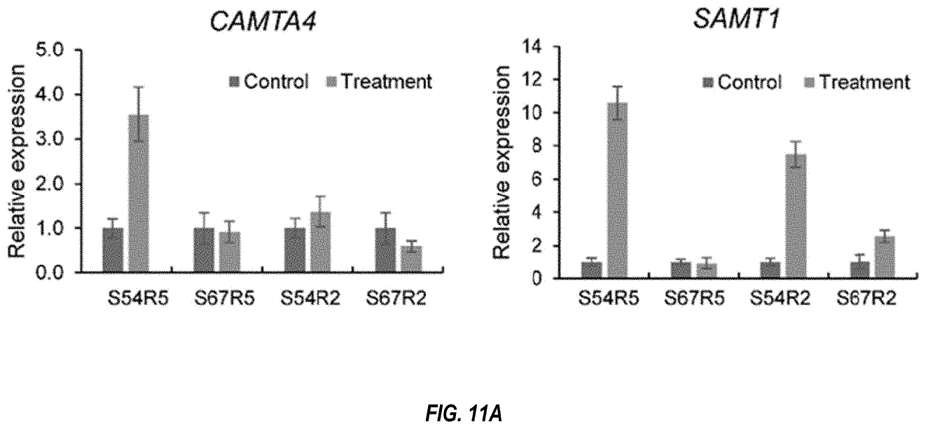

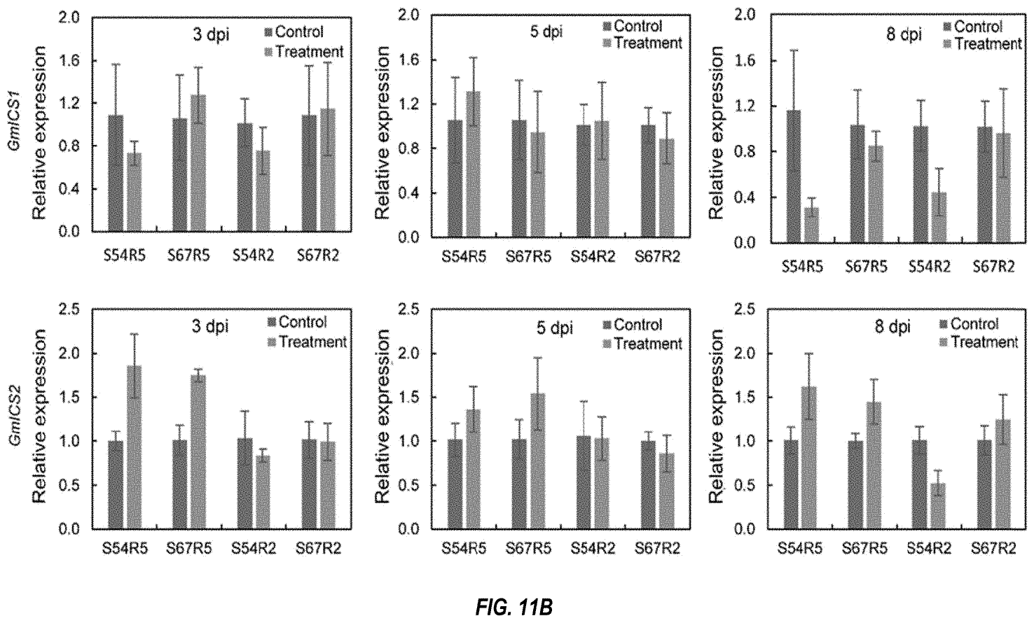

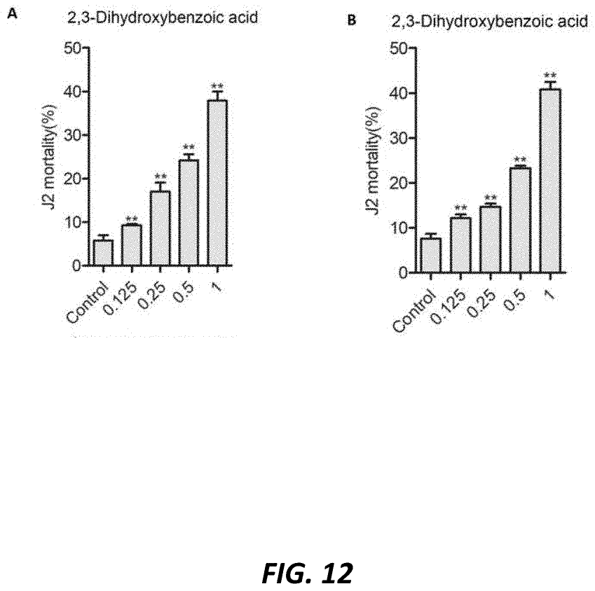

As shown in FIG. 3, the expression of all five genes was significantly up-regulated in S54 upon the infection by both race 2 and race 5 (compared with non-infected controls) over the time course of infection, with expression peaks observed at varying time points post-inoculation. Notably, these selected genes showed very similar expression patterns in the infected S54 roots over the time-course of infection, indicating that these genes were closely related and coordinately expressed during the defense response. In contrast, in S67, no significant expression changes, including down regulation, were observed for these genes in roots inflected by either race. Another two known genes, SAMT1, which encodes a SA methyltransferase involved in SA-mediated defenses, and CAMTA, which encodes a Ca2+/calmodulin-binding transcription factor, were also found to be up-regulated in infected S54 roots, but were not up-regulated in infected S67 roots (FIG. 11A). These results collectively indicate that a set of closely-related genes involving a variety of defense-related pathways were commonly induced by the two races and that the significant up-regulation of the key regulatory genes in Ca²⁺ and SA signaling pathways may play an important role in the increased resistance of S54 to both races.

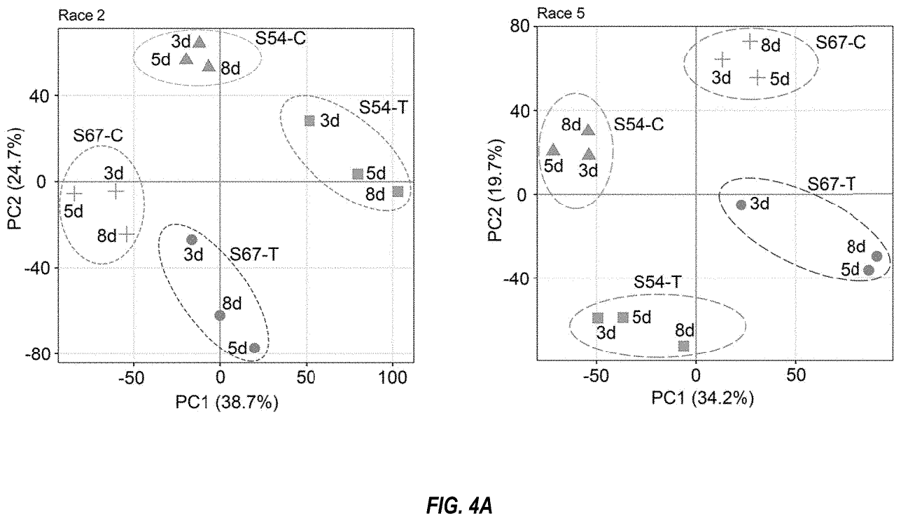

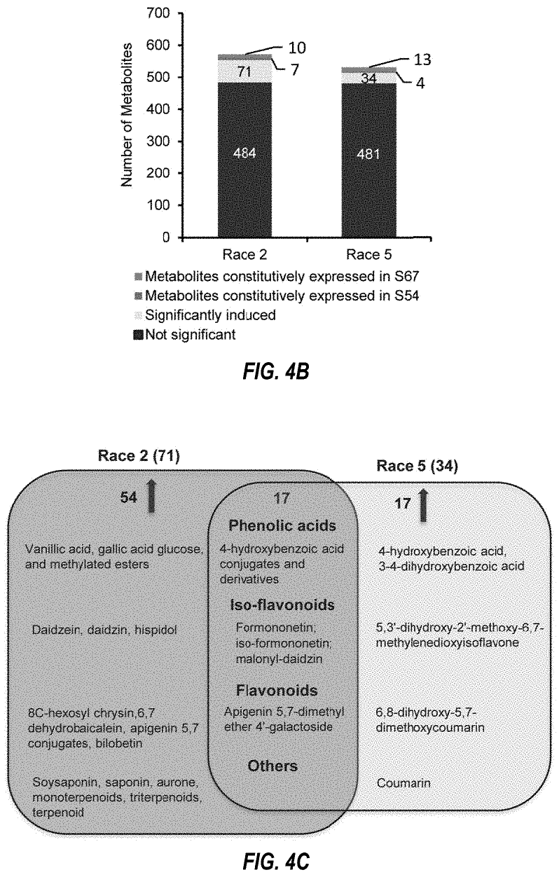

Global analysis of metabolic changes in G. soja roots infected by H. glycines. In addition to molecular responses, metabolic changes upon the infection may also contribute to H. glycines resistance. An untargeted strategy using LC-MS metabolomics profiling detected a total of 572 and 532 high-quality peaks for races 2 and 5, respectively. Principal component analysis (PCA) of these expressed compounds showed that the metabolite data was able to distinguish both the effect of SCN infection and genotype-specific difference by PCs 1 and 2, respectively (FIGS. 4A-4B). Additionally, the metabolites closely clustered in each genotype per condition at all three testing points were clearly separated from other conditions. The clear separation between the control samples of each genotype suggests these S54 and S67 roots have naturally different secondary metabolite metabolisms, which may confer their different metabolic responses to H. glycines infection. As expected, ANOVA between conditions per race across all time points indicated a significant induction of the root metabolome by H. glycines infection. In total, 71 metabolites were strongly induced in race 2-treated S54 roots (S54_T_R2), while 34 metabolites were significantly induced in race 5-treated S54 roots (S54_T_R5), with 17 of these metabolites commonly induced by both races (FIG. 4C).

Phenolic compounds were strongly induced by H. glycines. A close investigation of the induced metabolites indicated that 26 (55.3%) of the 47 known compounds induced under race 2, and thirteen (59.1%) of the 22 known compounds induced under race 5, were phenolic compounds (phenolic acids, iso-flavonoids, and flavonoids). Other than phenolic compounds, terpenoids and saponins were also induced. A comparison of the two metabolite data sets allowed us to identify commonly differentially expressed metabolites (cDEMs), and nine (75%) of the 12 known metabolites belonged to phenolic compounds (FIG. 4C, Table 2). Notably, two of the cDEMs, namely, 3 4-dihydroxybenzoic acid and/or 2,3-dihydroxybenzoic acid, a phenolic acid showing nematocidal activity against root-knot nematode (Meloidogyne incognita), and formononetin, an isoflavonoid produced in legumes showing disease resistance, are known to be involved in plant defenses. There are few reports on the involvement of the other seven metabolites in plant defense.

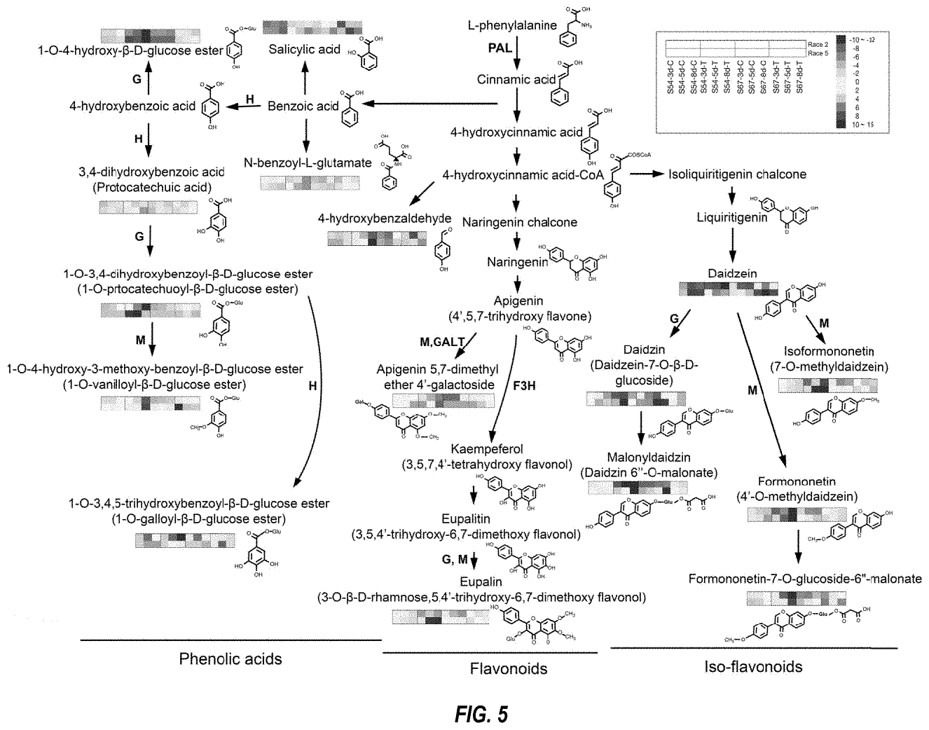

To understand the metabolic relationships among these induced metabolites, we intercalated the nine cDEMs and several race-specific metabolites (such as daidzein and daidzin) and their respective compound structure into the phenolics biosynthesis pathway map (FIG. 5). In FIG. 5, the heat map represents the expression patterns of metabolites during the time course of treatment. Enzymatic steps catalyzed by hydroxylases, methyltransferases, glycosyltransferases, and galactosyltransferase are indicated with capitalized H, M, G, and GALT, respectively. F3H is short for flavonoid 3-hydroxylase. PAL is short for phenylalanine ammonia lyase. These phenolic compounds are derivatives synthesized from a common precursor, L-phenylalanine, via the shikimate metabolic pathway (FIG. 5). Of the nine cDEMs, three, four and two were mapped on the rarely studied phenolic acid pathway, the iso-flavonoid pathway, and the flavonoids pathway, respectively, based on a previous report and their structures. In addition, we observed that these cDEMs showed dynamic patterns in accumulation patterns in response to infection over the time course of the treatments. These metabolites have different accumulation and abundance patterns in S54 roots between two races; most showed a gradual increase beginning at 3 dpi under race 2 infection, while most showed a sudden increase at 8 dpi under race 5 infection. For both races, the highest accumulation of most of these metabolites occurred at 8 dpi (FIG. 5). In the infected S67 roots, these cDEMs also showed varying accumulation patterns upon infection, with some gradually increasing at 5 dpi or 8 dpi under infection by both races, but the increases were lower in S67 than in S54. Nevertheless, significant increases in the phenolic acid and polyphenolic compounds (flavonoids and iso-flavonoids) were clearly observed, suggesting that the three metabolic pathways (phenolic, flavonoid and isoflavonoid pathways) were strongly induced after H. glycines infection. Given that several plant phenolic compounds have demonstrated roles in disease resistance we hypothesize that these cDEMs synthesized from the phenolic, flavonoid, and iso-flavonoid metabolic pathways may have nematocidal activities against both races of H. glycines in S54.

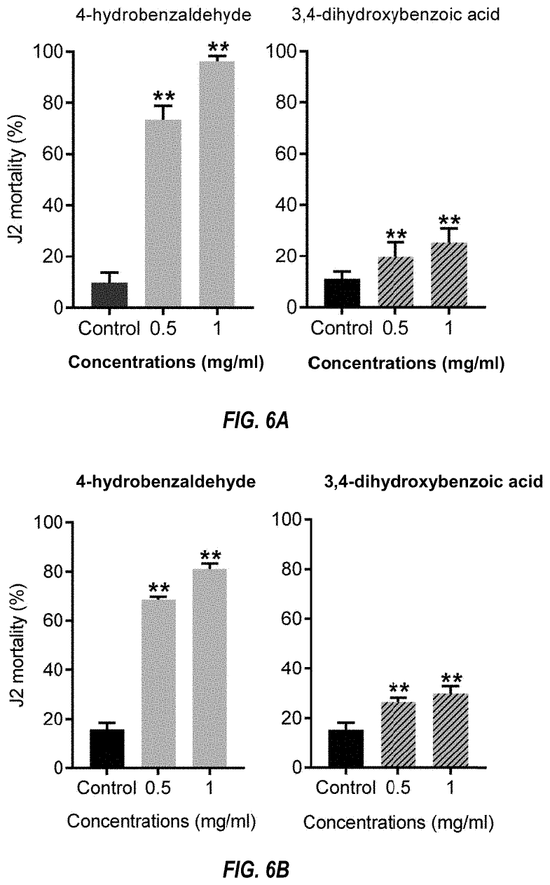

Phenolic acids show nematocidal activity against H. glycines. We next selected two water-soluble phenolic acids, 4-hydroxybenzaldehyde and 3 4-dihydroxybenzoic acid and/or 2,3-dihydroxybenzoic acid, to treat vigorous second-stage nematodes (J2) to test whether the two H. glycines-induced phenolic compounds could show efficient nematocidal activity against the two races (FIG. 6). Twenty-four hours after incubation with 4-hydroxybenzaldehyde and 3,4-dihydroxybenzoic acid and/or 2,3-dihydroxybenzoic acid, we found that the J2 mortality of both races was significantly higher compared than that in the non-treated controls, and J2 mortality increased with increasing compound concentration, suggesting that the J2 mortality was dose-dependent for both compounds. In addition, both compounds showed significant differences in toxicity against the two races, with 68% and 96% J2 mortality for 4-hydroxybenzaldehyde and 19% and 30% J2 mortality for 3,4-dihydroxybenzoic acid and/or 2,3-dihydroxybenzoic acid for both races observed at 0.5 mg/ml and 1.0 mg/ml, respectively. Overall, both 4-hydroxybenzaldehyde and 3,4-dihydroxybenzoic acid and/or 2,3-dihydroxybenzoic acid demonstrated nematocidal activity against races 2 and 5.

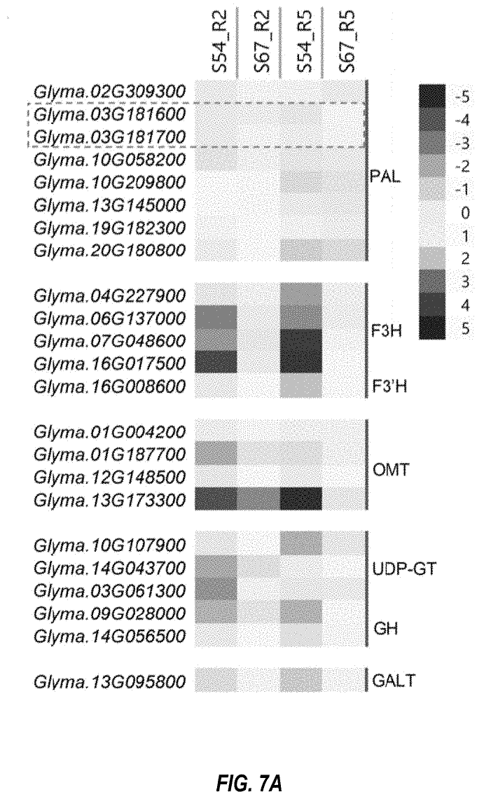

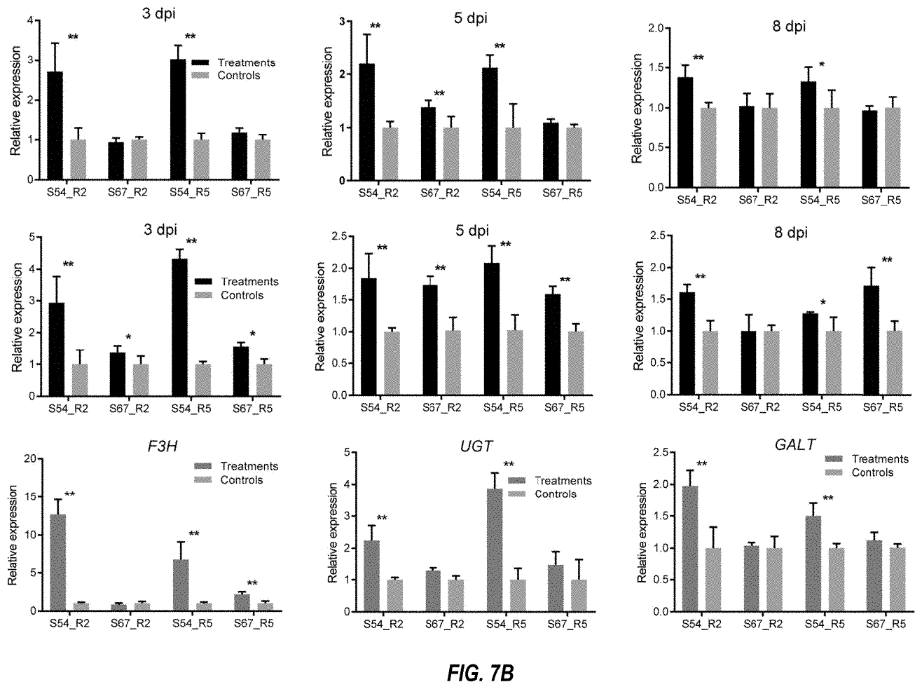

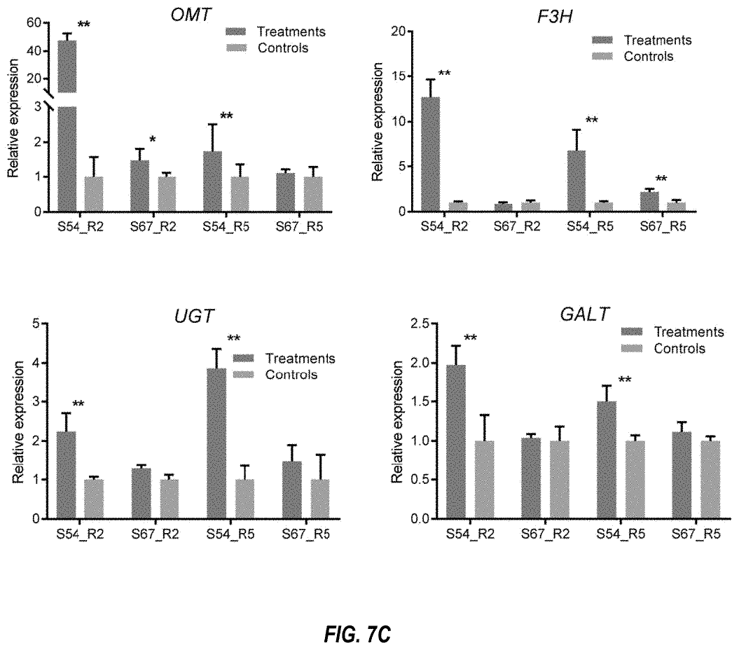

Candidate cDEGs associated with the production of cDEMs. The structure comparison and metabolic relationships suggested that these cDEMs are conjugates of benzoic acid, 4-hydroxybenzoic acid, daidzein, daidzin, apigenin, and eupalitin, with their ester or hydroxyl group methylated and glycosylated, accordingly. This result further suggested that modification enzymes, such as methyl transferase, hydroxylase, galactosyltransferase, and UDP-glycosyltransferases, that catalyze methylation, hydroxylation, and glycosylation may play important role in the accumulation of these cDEMs. The increased abundances of these cDEMs might be attributed to the enhanced expression of genes encoding the above-described tailoring modification enzymes. In agreement with metabolite result, we observed that several cDEGs potentially involved in these metabolic processes were consistently up-regulated upon the infection by both races. These genes include: F3Hs, encoding flavanone 3-dioxygenases, a key enzyme group involved in the flavonoid biosynthesis, F3′H, encoding flavonoid 3′-hydroxylase, OMT encoding O-methyltransferase, which is involved in the methylation of hydroxyl groups of isoflavanones/flavanones, and UGT and GALT, encoding UDP-glycosyltransferase and galactosyltransferase, respectively, which are involved in transfer of glycosyl groups (FIG. 7A). Glycosyl hydrolases associated with hydrolysis and/or rearrangement of glycosidic bonds were also found to be consistently up-regulated.

We subsequently performed qPCR to verify the induction of these genes in root tissues sampled at 8 dpi, the time at which the strongest increase in abundance of the associated metabolites was observed (FIG. 7A). Two highly-induced PAL genes that encode phenylalanine ammonia lyases, which catalyze the first key step of the shikimate pathway, were also included in the analysis. Consistent with metabolomics data, we verified that all four selected genes showed significantly higher accumulation in the infected S54 roots than in the infected S67 roots (FIGS. 7B-7E). A significant increase in expression of two PAL genes was observed at 3 dpi and 5 dpi rather than 8 dpi, in agreed with the metabolite data. The consistency in the expression of these pathway genes and associated metabolites indicates the robustness of integration of transcriptomics and metabolomics data and suggests that these cDEGs may be important in the diversity of the cDEMs that enable S54 to resist H. glycines.

Novel SCN resistance mechanisms in wild soybean genotype S54. Wild soybean is a novel alternative in dissecting and understanding the molecular mechanism underlying broad resistance to SCN, towards the goal of developing broad-spectrum soybean cultivars for SCN management. As observed in the wild relatives of other crop relatives, G. soja harbors a higher genetic diversity but is less explored than cultivated soybean. In particular, approximately 50% of the annotated resistance-related genes in G. soja have been lost in cultivated soybeans, including the novel salt tolerance gene GmCHX1 that was identified in G. soja. As the progenitor of G. max, G. soja may be important in developing SCN-resistant soybean cultivars because G. soja has a wide ecological and geographical distribution across East Asia, where SCN populations most likely originated. For SCN resistance, thus far, rhg1 and Rhg4 are the two major loci conferring SCN resistance that have been well-studied in G. max. Several lines of evidence have proved that the SCN resistance mechanism in the resistant genotype S54 differs from previously identified defense mechanisms mediated by rhg1 and Rhg4: (1) S54 contains Lee74-type (SCN susceptible) Rhg4 and rhg1 alleles, which differ from those of the resistant soybean genotypes Peking and PI88788 (Table 4); and (2) our findings suggest that S54 may have a novel SCN resistance-conferring genetic mechanism other than by Rhg4 and rhg1. Thus, identification of the underlying genetic variation in S54 may enrich the currently known sources of SCN resistance benefiting the soybean improvement. Novel alleles originated from wild gene pools have been used to improve the cultivated descendants in many other crop species, for example, alleles from Mexican maize (Tripsacum dactyloides L.) have increased corn blight resistance in maize, alleles from gama grass (Tripsacum dactyloides L.) have increased rootworm resistance in maize, and TmHKT1;5-A from a wild wheat ancestor (Triticum monococcum L.) has improved salt tolerance in wheat. These results suggest that G. soja may represent an important gene pool that can be tapped to identify novel SCN-resistant gene/alleles for G. max improvement, and meanwhile, further dissection of the genetic basis of SCN resistance in S54 may significantly increase our understanding of the complex mechanism of SCN-plant interactions.

Broad-spectrum resistance of S54 to soybean cyst nematodes. Breeding soybean varieties with broad-spectrum resistance to diverse pests is one of the central goals of soybean improvement. As the most damaging soybean pathogen worldwide, H. glycines is probably the most difficult to manage and least understood pathogen because of its broad virulence variability (16 races) and rapid race shifts. Like pathogen/insect resistance in other plant species, the majority of the resistant G. max genotypes, thus far, are race-specific, and no one genotype has been identified that is resistant to all races. Race shifts have decreased the effectiveness of PI88788-derived resistance in mitigating damage caused by SCN race 3, which is a setback to many efforts made by geneticists and breeders over the past decades. In this case, planting diverse resistant or varieties with broad resistance to several races may be helpful to prolong the durability of SCN resistance effectiveness. In terms of broad resistance, S54 showed high resistance to both races 2 and 5 and has great potential for breeding soybean varieties with broad-spectrum resistances to SCN. Previous studies have focused mostly on race 3, which dominates the soybean-growing fields in the central United States, while races 2 and 5 are commonly found in the southeastern United States and are rarely studied. Meanwhile, although time-consuming and technically challenging, combining S54-derived resistance with resistant rhg1 and Rhg4 alleles into one elite soybean variety could be a practical strategy to breed durable, resistant soybean that may grow at a broad range of cultivation areas infected by these races. A previous study showed that stacking SCN resistance QTLs from wild soybean and soybean could increase SCN resistance.

Integration of multiple “omics” in dissecting SCN resistance. The study provides comprehensive and dynamic changes in both transcriptomics and metabolomics with SCN infection, which could not be achieved by one method alone, by gene-specific expression profiling or by targeted metabolite analysis alone. Microarray- and sequencing-based transcriptome analysis may successfully uncover a variety of genes that are differentially expressed in SCN-treated roots, but cannot reflect physiological status of soybean roots during the defense responses. Compared to transcriptome analysis, the time course metabolomic analysis reflected more dynamic metabolomic changes in roots under SCN infection. Beyond a single or targeted analysis, our study complementarily compared transcriptomic and metabolomic alternations, and this integrated analysis allowed us to observe a global picture of the common defense of S54 against races 2 and 5 at both the gene regulation and metabolic levels. Our result suggested that Ca²⁺-SA signaling cascade may serve a central role in the early response to infection, in the subsequent regulation of a vast array of genes involved in PTI and ETI, and in the metabolism of energy- and defense-related metabolites (FIGS. 4 and 5), thus enabling efficient defenses against SCN infection. Therefore, the integration of multiple “omics” analyses may represent an efficient strategy for dissecting and understanding the complex mechanisms of soybean-SCN interactions. The integration of diverse omics has also been widely employed in other species, such as nutritional stress responsiveness in Arabidopsis and corn and fish proximodistal development.

SCN resistance in wild soybean genotype S54 genes, secondary compounds, and pathways. Our integrative metabolomics and transcriptomics analysis revealed a subset of cDEG and cDEM candidates potentially involved in broad-spectrum resistance to SCN. Although no transient change in cytosolic Ca²⁺ under infection was determined here, the strong induction of Ca²⁺ signaling-related genes may suggest that Ca²⁺ signaling may function conservatively during the soybean-SCN interaction, as observed in other plant species. The similarity in the SA accumulation patterns of S54 and S67 upon SCN infection was elusive. This may be explained because, as we observed in our results (FIG. 5), S54 may have a more efficient metabolic pathway than S67 in converting SA to its derivatives, or to other phenolic acids with nematocidal activity, to maintain an optimal level of endogenous SA and activate defense responses. In agreement with a recent study, our results verified that PALs may have important functions in the metabolism of SAs other than ICSs in soybean. Most importantly, our integrated study tightly links several genes encoding tailoring modification enzymes with several uncharacterized cDEMs potentially involved in nematode resistance, filling the gap between the regulation of cDEGs and cDEMs involved in phenylalanine metabolism during the defense response. The up-regulation of these enzymes catalyzing compound modification may lead to the accumulation of intermediate or novel natural compound derivatives with diverse patterns of glycosylation, hydroxylation, and methylation, leading to an increase in the diversity of product properties, which make S54 more resistant to SCN than S67. Further research focusing on the joint study of these genes and metabolites may yield a better understanding of how soybean plants regulate these enzymes and metabolites in response to H. glycines infection.

Plant phenolics are ubiquitous secondary metabolites found throughout the plant kingdom. Accumulation of phenolics begins with the activation of PTI, which involves a variety of membrane-harbored protein kinases (PKs), the pattern recognition receptors that were strongly induced in our study (FIG. 2). Flavonoids and iso-flavonoids, such as daidzein and formononetin, which accumulated in our study and previous studies, have been found to act as phytoalexins and nematicides against soil-borne pathogens and root-feeding-insects. Flavonoids, the major polyphenols in most legume plants, especially in roots, are well studied, while the metabolism and regulation of phenolic acids have not received as much attention as those of flavonoids. Although SA may be one of the most studied phenolic acid that serves as a signaling molecule triggering priming in systemic plant immunity, SA shows no direct nematocidal activity. Consistent with previous studies, we observed enhanced SA biosynthesis in infected roots of S67 and S54, regardless of the resistance difference between them, which is consistent with the fact that SA is important for basal defenses. In contrast, the distinct expression patterns of selected SA-signaling genes (FIG. 3) suggest that distinct SA-signaling transduction systems, between S67 and S54, discriminatorily activated downstream defense-related genes, thus leading to the difference in resistance. As the expression levels of these signaling-related cDEGs and the abundance of the cDEMs increased in the S54 roots under infection (FIGS. 3 and 5), the degree of SCN resistance increased gradually. This is consistent with the results of our previous study, that is, the SCN development in S54 roots at 8 dpi was much more inhibited than the SCN development in S54 roots at 3 dpi and 5 dpi. The identification of nematocidal activity of 3,4-dihydroxybenzoic acid and/or 2,3-dihydroxybenzoic acid and 4-hydroxybenzaldehyde against H. glycines opens avenues to use naturally produced plant compounds to mitigate the impact of nematode damage on soybean. In addition, other phenolic acids that were exclusively induced in S54 in response to both SCN races deserve further study in the determination of nematocidal activity.

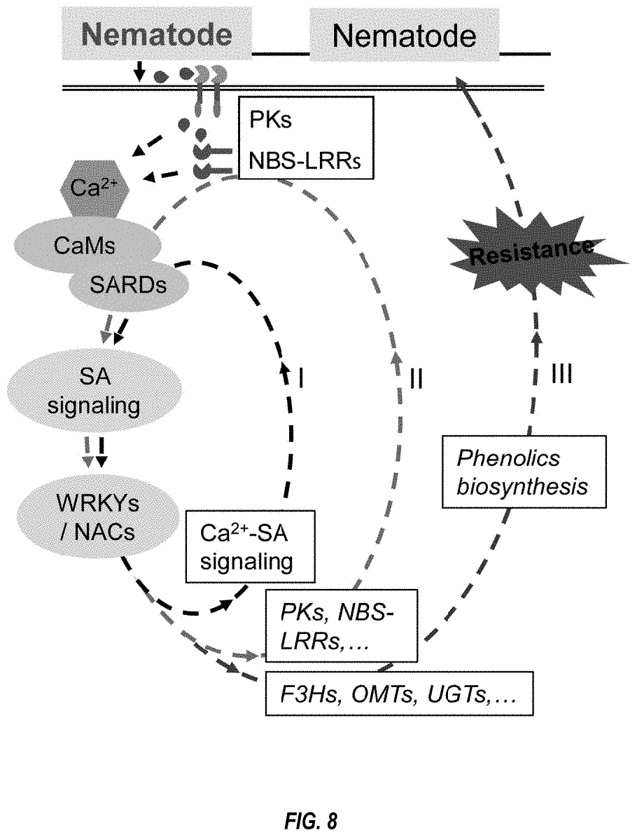

As shown in FIG. 8, during resistance response, virulent effectors secreted by H. glycines could be recognized by membrane-anchored receptors (such as receptor-like protein kinases) and cytoplasmic receptors (such as NBS-LRRs), the resultant defense signals were transduced to cell nucleus to activate the transcription of defense-related genes. The defense signals were gradually amplified as expression of genes involved in recognition of invaders and Ca2+-SA-WRKY/NACs signals transduction cascade were enhanced. Significantly amplified defense signals enhanced the transcription of enzyme-encoding genes (such as F3H, OMT, UGT) participating in phenolic biosynthesis pathway in S54, leading to rapid accumulation of phenolic acids, flavonoids, and iso-flavonoids with nematicidal activity (such as 4-hydroxybenzaldehyde and 3,4-dihydroxybenzoic acid and/or 2,3-dihydroxybenzoic acid) and resistance response to H. glycines in S54.

### Methods

Plant materials and SCNs. Seeds of two G. soja genotypes (S54 and S67) and seven HG type indicator lines (Peking, PI88788, PI90763, PI437654, PI209332, PI89772, and PI548316) were obtained from USDA Soybean Germplasm Collection (www.ars-grin.gov/). Williams 82 was used as a susceptible check in resistance screening. Two HG types of SCN, namely, 1.2.5.7 (previously known as race 2) and 2.5.7 (previously known as race 5) were used. HG types were determined using seven indicators as previously described. Both HG types were separately reared on soybean cv. Williams 82 grown in clay pots filled with sand under controlled greenhouse conditions (27° C., 16 hours light/8 hours dark) for more than 30 generations.

Plants preparation, SCN inoculation, and sample collection. Seed preparation, germination, transplanting, and SCN inoculation were performed as previously described. Briefly, G. soja seeds were surface sterilized with 0.5% sodium hypochlorite for 60 seconds, rinsed with autoclaved water, and then placed on a piece of wet sterile filter paper in a petri dish for germination. After 2-3 days, each healthy seedling was transplanted into a container (Greenhouse Megastore, Danville, Ill., USA) filled with sterile sand. Three days after transplantation, health seedlings were used for inoculation for resistance determination and sample collection for RNA-seq. A randomized complete block design was used for cone-contained seedlings arrangement. The resistance response of G. soja to SCN was determined as previously described. The roots of each individual plant were inoculated with 2500 fresh SCN eggs, and the female cysts were collected from the individual roots and the soil and counted under a stereomicroscope 35 days after inoculation. Four biological replicates per genotype were used, and the average number of females was used to calculate female Index (FI): FI=(number of females on a given individual/average number of females on the susceptible control)×100. All plants were maintained in the growth chamber (Percival, Perry, Iowa, USA) under the controlled conditions at 27° C., 16 hours light/8 hours dark and 50% relative humidity throughout the assay.

For nematodes preparation, cysts were collected from stock roots that had been maintained in the same greenhouse. Briefly, SCN cysts were harvested by massaging the stock roots in water and sieving the solution through nested 850 and 250 μm test sieves (Fisher Scientific, Suwanee, Ga., USA). The collected cysts were crushed with a rubber stopper in a 250-μm sieve, the released eggs were collected in a 25-μm mesh sieve. The eggs were then purified by sucrose flotation with some modifications. For nematode hatching, purified eggs were placed on a wet paper tissue in a plastic tray with appropriate level of water, which was covered with aluminum foil in an incubator maintaining at 27° C. for 3 days. Hatched second-stage juvenile nematode (J2) were collected and suspended in 0.09% liquid agarose at a final concentration of 1,800 J2/ml. For inoculation, 1 ml of J2 inoculum was added on each root as treatment, and seedlings inoculated with 0.09% agarose were used as non-infected controls. Three days post-inoculation, three roots of randomly selected seedlings were stained with acid fuchsin to validate the successful inoculation and investigate the growth of nematode in the roots as previously described.

Root tissues were separately prepared for transcriptome sequencing and LC-MS analysis and sampled at 3 days, 5 days, and 8 days post-inoculation (dpi) (FIG. 1B). For RNA-seq, root tissues from four individuals were pooled as one biological replicate, and three replicates were collected for each condition. Each biological replicate collected at 3 dpi, 5 dpi, and 8 dpi for each condition were pooled as one biological replicate; thus, twelve samples were prepared for RNA-Seq library construction. For LC-MS analysis, roots from 3-5 plants per condition were collected, weighed, and analyzed individually. All samples were immediately frozen in liquid nitrogen and stored at −80° C.

RNA extraction, transcriptome sequencing, and data analyses. RNA was isolated using RNeasy Plant Mini Kit (Qiagen, Hilden, Germany) following the manufacturer's instructions and quantified using a NanoDrop 2000 (Thermo Fisher Scientific, Waltham, Mass., USA). RNA integrity, purity, and concentration were assessed using an Agilent 2100 Bioanalyzer with an RNA 6000 Nano Chip (Agilent Technologies, Santa Clara, Calif., USA). Prior to library construction, total RNA was treated with RNase-free DNase I (New England Biolabs, Ipswich, Mass., USA) to remove any contaminating genomic DNA. Messenger RNA (mRNA) was purified using the oligo-dT beads provided in the NEBNext Poly(A) mRNA Magnetic Isolation Module (New England BioLabs, Ipswich, Mass., USA) following the manufacturer's directions. Complementary DNA (cDNA) libraries for Illumina sequencing were constructed using the NEBNext Ultra Directional RNA Library Prep Kit (NEB, Beverly, Mass., USA) and NEBNext Multiplex Oligos for Illumina (New England BioLabs) using the manufacturer-specified protocol as previously described. The amplified library fragments were purified and checked for quality and final concentrations using an Agilent 2200 TapeStation (Agilent Technologies, Santa Clara, Calif., USA). The final quantified libraries were pooled in equimolar amounts for sequencing on an Illumina HiSeq 2500 utilizing a 125-bp read length with v4 sequencing chemistry (Illumina, San Diego, Calif., USA).

After removal of sequencing adaptor and low-quality reads using Trimmomatic (v 0.36), clean reads were aligned to soybean reference genome (version Wm82.a2.v1, downloaded at https://phytozome.jgi.doe.gov) using TopHat as previously described. The number of reads mapping to annotated genes was counted using featureCounts, and analyses of differentially expressed genes (DEGs) were performed using EdgeR. A gene with fdr<=0.01 and fold change>=1.5 was considered significantly differentially expressed between treatments and controls. Enrichment analysis for GO terms and KEGG pathways were performed as previously described. For the construction of the co-functional regulatory network, we extracted the links with known regulatory relationships between genes from SoyNet database and visualized the network with Cytoscape.

Quantitative real-time PCR analysis. RNA extraction from the root tissues for qPCR and genomic DNA removal using DNase I were conducted with the same protocols described above. Reverse transcription reactions were performed using RevertAid First Strand cDNA Synthesis Kit (Thermo Fisher Scientific, Waltham, Mass., USA) following the manufacturer's instruction. Quantitative real-time PCR (qPCR) was performed using PerfeCTa™ SYBR® Green FastMix™ (Quanta Biosciences, USA) on an ABI7500 Fast real-time PCR system (Applied Biosystems, USA). Three biological replicates were per sample were used for qPCR, and each reaction was repeated twice. The soybean Ubiquitin 3 gene (GmUBI-3, Accession D28213) was used as an endogenous control. All primers used in this study are listed in Table 1.

Metabolite extraction, data processing, and data analysis. Metabolites were extracted from each root tissue and the resulting data were processed as previously described. Briefly, root tissues were extracted with 50% (v/v) methanol at 60° C. water bath for 30 min. A tissue-to-solvent ratio (w/v) of 1:10 was used constantly across all of the samples. Extracts were filtered using 0.2-μm filter prior to LC-MS profiling on a G6530A Q-TOF LC/MS (Agilent Technologies, USA). Peaks consistently detected in at least three biological replicates within each group at each time point were used for downstream analysis. The metabolites identities were confirmed by using a pool of pure standard compounds, including daidzein, daidzin, genistein, genistin, formononetin, salicylic acid (2-hydroxybenzoic acid), 3-hydroxybenzoic acid, 4-hydroxybenzoic acid, 3,4-dihydroxybenzoic acid and/or 2,3-dihydroxybenzoic acid (protocatechuic acid) and 4-hydroxybenzaldehyde. All remaining peaks were annotated according to the mass match with Kyoto Encyclopedia of Genes and Genomes (KEGG), Plant Metabolic Network (PMN) at SoyCyc database (www.plantc100yc.org/), and an in-house database.

Analysis of metabolomics data was performed using MetaboAnalyst. Briefly, cube root transformation was conducted for all numerical data transformed from the peak areas for data normalization and Pareto scaling in an effort to reduce the undesired biasedness and to show the biologically relevant differences for each compound among different groups. One way ANOVA with Fisher's LSD post-hoc analysis (FDR<5%) was performed using normalized data were used to determine the differentially expressed metabolites by comparing four groups (S54_T, S54_C, S67_T, and S67_C) at each time point. The metabolites significantly inducted in S54_T compared with other three groups with the challenges by both races (2 and 5) were considered as the metabolites showing potential broad-spectrum resistance. The metabolites that were strongly induced in both treatments and controls of one genotype at all three time points but not induced in the other genotype were regarded as constitutively expressed metabolites. For data visualization, principal component analysis (PCA) was conducted with R package princomp using all detected high-confidence metabolites. Heat maps illustrating the comparison of expressed metabolites were made using JMP pro 13 (SAS Institute Inc., Cary, N.C.). Biological databases including KEGG, Metacyc (https://metacyc.org/) and the plant metabolic network (PMN) of Soycyc were used as a reference for the mapping of different metabolites into their corresponding pathways.

Nematocidal activity assay. Determination of the nematocidal activity of phenolic compounds was conducted as previously described. Briefly, approximately 400 freshly hatched J2s in 900 μl of water were added to each well of a 24-well Microtest™ tissue culture plate, and 100 μl of the compound test solution was added at concentrations of 5 mg/ml and 10 mg/ml. Therefore, the final concentration of each compound in each suspension is 0.5 mg/ml and 1.0 mg/ml. Control samples received 100 μl of water. Three replicates per concentration were used. The plate was covered with the original solid lid and wrapped with Parafilm®, and samples were kept at 27° C. in an incubator. After 24 hours of incubation, dead and alive J2 nematodes were counted using a stereo microscope Leica M165 FC (×40) to evaluate mortality rates. J2 mortality can be estimated according to the mean percentage of dead J2 in the total number of J2 (alive and dead). Nematodes are considered dead when no movement was observed during 3 seconds of observation. The compounds 3,4-dihydroxybenzoic acid and/or 2,3-dihydroxybenzoic acid and 4-hydroxybenzaldehyde are commercially available at Sigma-Aldrich, USA.

Our study dissected the network and key factors involved in broad-spectrum SCN resistance in wild soybean by performing comparative analyses of transcriptomic and metabolomic changes between the resistant genotype S54 and susceptible genotype S67, which different responses to infection by race 2 or race 5. The systematic study and global analysis uncovered a novel defense mechanism conferring resistance to multiple races of SCN that have not been previously reported. The results indicate that the initiation of effective Ca²⁺-SA signaling pathways represents one of the most important and earliest events in the regulation of downstream defense-related genes. The synthesis of plant secondary metabolites, i.e., phenolic compounds, was significantly enhanced in S54 compared with that in S67. Analysis of the induced phenolics suggested that tailoring modification enzymes, such as hydroxylases, methyltransferases, and UDP-glycosyltransferases, play an important role in the production of diverse phenolic derivatives and conjugates, enhancing the plasticity of plant defenses. The efficient nematocidal activity of phenolic acids was also detected, offering an alternative to the environmental-friendly chemical control of SCN.

TABLE 2
Compounds commonly induced by races 2 and 5

| Common in | | |
|---|---|---|
| both races | Common Compounds Names | Compounds Belongs to Category |
| 15 | 1-O-4-hydroxybenzoyl-beta-D-glucose ester | Phenolic acid conjugate |
| 22 | 4-hydroxybenzaldehyde | Phenolic acid |
| 39 | Formononetin (expressed higher at 8 dpi) | Iso-flavonoid methyl conjugate |
| 40 | Formononetin-7-O-glucoside-6″-malonate | Iso-flavonoid glucosil and malonyl conjugate |
| 43 | Furaneol glucopyranoside | Furaneol (methyl and hydroxy derivative of furanone) |
| | | attatch with glucose pyran ring structure |
| 53 | Isoformononetin | Iso-flavonoid methyl conjugate |
| 57 | Malonyl-daidzin | Iso-flavonoid malonyl conjugate |
| 59 | N-Benzoyl-L-glutamate | Ammo Acid conjugate of Phenolic Acid |
| 160 | 2 -Phenylethyl O-beta-D-xylopyranosyl- | Phenyl (C6H5) with ethyl and its |
| | (1-2)-beta-D-glucopyranoside | xylose and glucose conjugate |
| 201 | Apigenin 5,7-dimethyl ether 4′-galactoside | Flavanoid galactoside conjugate |
| 204 | Decaffeoylverbascoside | Rhamnose and glucose sugar with phenyl |
| | | ethanoid (2-hydroxytyrosol and phenyl |
| | | propanoid (caffeic acid) combination |
| 215 | Eupalin | Flavonol conjugate (3-hydroxy |
| | | flavones Eupalitin conjugate) |
| 94 | NA | X |
| 112 | NA | X |
| 116 | NA | X |
| 155 | NA | X |
| 164 | NA | X |
| 171 | NA | X |

TABLE 3

| | | | | | Percentage |
|---|---|---|---|---|---|
| | | | | | of |
| | | | | Percentage | uniquely |
| | | Sample ID | Total reads | kept | mapped |
| A3 | Treatment | S54_T1 | 18,507,367 | 99.48% | 80.77% |
| | | S54_T2 | 16,120,518 | 99.43% | 83.02% |
| | | S54_T3 | 19,655,772 | 99.48% | 80.94% |
| | Control | S54_C1 | 20,882,964 | 99.56% | 81.63% |
| | | S54_C2 | 19,892,139 | 99.50% | 82.65% |
| | | S54_C3 | 26,343,674 | 99.51% | 83.05% |
| Race 5 | Treatment | S67_T1 | 21,081,804 | 99.54% | 83.85% |
| | | S67_T2 | 21,080,418 | 99.29% | 82.89% |
| | | S67_T3 | 19,883,935 | 99.49% | 83.08% |
| | Control | S67_C1 | 20,374,885 | 99.52% | 85.85% |
| | | S67_C2 | 21,954,754 | 99.56% | 87.40% |
| | | S67_C3 | 18,887,089 | 99.54% | 87.93% |
| Race 2 | Treatment | S54-C1 | 21,919,401 | 98.95% | 64.60% |
| | | S54-C2 | 22,593,752 | 98.67% | 78.50% |
| | | S54-C3 | 22,974,266 | 98.95% | 77.80% |
| | Control | S54-T1 | 25,417,645 | 99.14% | 80.60% |
| | | S54-T2 | 20,594,762 | 99.08% | 71.80% |
| | | S54-T3 | 21,531,309 | 99.01% | 66.30% |
| | Treatment | S67-C1 | 19,207,038 | 99.10% | 85.20% |
| | | S67-C2 | 21,531,470 | 99.09% | 86.70% |
| | | S67-C3 | 21,827,966 | 98.77% | 82.70% |
| | Control | S67-T1 | 18,410,280 | 98.79% | 79.90% |
| | | S67-T2 | 18,320,407 | 98.76% | 82.90% |
| | | S67-T3 | 18,835,289 | 97.50% | 81.00% |

TABLE 4
Genotypes of a wild soybean genotype S54 with
SCN resistance at the Rhg1 and Rhg4 loci

| | Resistance or | GSM0381 | GSM0383 | GSM0191 |
|---|---|---|---|---|
| Genotype | Susceptible | (rhg1) | (rhg1) | (Rhg4) |
| Peking | Resistant check | GG | GG | GG |
| PI 88788 | Resistant check | GG | CC | CC |
| Lee 74 | Susceptible check | TT | CC | CC |
| S54 | Resistance | TT | CC | CC |

That which is claimed is:

1. A method of reducing soybean cyst nematode infection in a plant, the method comprising contacting the plant or plant part thereof, and/or a growing media in which the plant is grown, with a composition comprising at least one water-soluble phenolic acid in an amount effective to reduce nematode infection, wherein the at least one water-soluble phenolic acid is 2,3-dihydroxybenzoic acid, thereby reducing the number of soybean cyst nematodes.

2. The method of claim 1, wherein contacting the plant or plant part with the composition occurs prior to or concurrently with planting the plant or plant part.

3. The method of claim 1, wherein contacting the growing media with the composition occurs prior to, concurrently with, or after planting the plant or plant part in the growing media.

4. The method of claim 1, wherein the plant part is a seed.

5. The method of claim 1, wherein the plant part is a root.

6. The method of claim 1, wherein the growing media is a soil, a soil-less media or sand.

7. The method of claim 1, wherein the plant or plant part and/or growing media is contacted with the composition at least one time.

8. The method of claim 1, wherein the at least one water-soluble phenolic acid is present in an amount of about 0.125 mg/ml to about 1 mg/ml.

9. The method of claim 1, wherein infection is reduced in the plant, compared to a plant that has not been contacted with the composition.

10. The method of claim 1, wherein the plant is Aeschynomene indica (Indian jointvetch), Beta vulgaris (beetroot), Cajanus cajan (pigeon pea), Fabaceae (leguminous plants), Geranium (cranesbill), Glycine, Glycine max (soybean), Kummerowia striata (Japanese lespedeza), Lamium amplexicaule (henbit deadnettle), Lamium purpureum (purple deadnettel), Lespedeza juncea var. Sericea (Sericea lespedeza), Lupinus (lupins), Lupinus albus (white lupine), Nicotiana tabacum (tobacco), Penstemon Phaseolus vulgaris (common bean), Pisum sativum (pea), Sesbania exaltata (coffeebean (USA)), Solanum lycopersicum (tomato), Stellaria media (common chickweed), Verbascum thapsus (common mullein), Vicia villosa (hairy vetch), Vigna aconitifolia (moth bean), Vigna angularis (adzuki bean), Vigna mungo (black gram), or Vigna radiata (mung bean).

11. The method of claim 10, wherein the plant is soybean.

12. The method of claim 1, wherein the composition is effective in increasing resistance in the plant or plant part thereof, and/or the growing media against one or more HG type of soybean cyst nematodes.

13. The method of claim 12, wherein the composition is effective in increasing resistance in the plant or plant part thereof, and/or the growing media against HG type 1.2.5.7 and HG type 2.5.7 soybean cyst nematodes.

14. A coated seed comprising a composition including at least one water-soluble phenolic acid in an amount effective to reduce infection of the seed by soybean cyst nematodes, wherein the at least one water-soluble phenolic acid is 2,3-dihydroxybenzoic acid.

15. The seed of claim 14, wherein the seed is coated with a composition comprising at least one water-soluble phenolic acid, soaked in a composition comprising at least one water-soluble phenolic acid, or soaked in a composition comprising at least one water-soluble phenolic acid and coated with a composition comprising at least one water-soluble phenolic acid.

16. The seed of claim 14, wherein the at least one water-soluble phenolic acid is present in an amount of about 0.125 mg/ml to about 1 mg/ml.

17. The seed of claim 14, wherein a plant grown from the seed coated with the composition has an increased tolerance to or reduced infection by nematodes as compared to an untreated seed.

18. The seed of claim 14, wherein the seed is Aeschynomene indica (Indian jointvetch), Beta vulgaris (beetroot), Cajanus cajan (pigeon pea), Fabaceae (leguminous plants), Geranium (cranesbill), Glycine, Glycine max (soybean), Kummerowia striata (Japanese lespedeza), Lamium amplexicaule (henbit deadnettle), Lamium purpureum (purple deadnettel), Lespedeza juncea var. Sericea (Sericea lespedeza), Lupinus (lupins), Lupinus albus (white lupine), Nicotiana tabacum (tobacco), Penstemon Phaseolus vulgaris (common bean), Pisum sativum (pea), Sesbania exaltata (coffeebean (USA)), Solanum lycopersicum (tomato), Stellaria media (common chickweed), Verbascum thapsus (common mullein), Vicia villosa (hairy vetch), Vigna aconitifolia (moth bean), Vigna angularis (adzuki bean), Vigna mungo (black gram), or Vigna radiata (mung bean).

19. The seed of claim 18, wherein the seed is a soybean seed.
